(19) United States
(12) Patent Application Publication
(10) Pub. No.: US 2026/0093314 A1
(43) Pub. Date: Apr. 2, 2026

(54) SYSTEM AND METHOD FOR ENHANCING AN IMMERSIVE ONLINE DIGITAL EXPERIENCE USING SUBVOCALIZATION AND GESTURE-BASED DETECTION CONTROL VIA LARYNX MEMBER AND AR

(71) Applicant: Infinitus Holdings Inc., Penn Valley, PA (US)

(72) Inventors: Joshua Ian Cohen, Penn Valley, PA (US); John Cronin, Jericho, VT (US)

(21) Appl. No.: 18/901,146

(22) Filed: Sep. 30, 2024

(51) Int. Cl. G06F 3/01; G06F 3/0346; G06F 3/044; G06Q 30/0601; G10L 15/22; G10L 15/24

(52) U.S. Cl. CPC G06F 3/011; G06F 3/016; G06F 3/017; G06F 3/0346; G06F 3/044; G06Q 30/0643; G10L 15/22; G10L 15/24; G10L 2015/223

(57) ABSTRACT

A system for enhancing an augmented reality (AR) and/or virtual reality (VR) experience, includes a larynx member comprising a piezoelectric sensing array configured to capture analog waveforms representing movements of a user's larynx muscles while subvocalizing and a processor configured to convert the analog waveforms into subvocalization data. The system also includes an AR/VR enhancement device comprising a communication interface configured to receive the subvocalization data from the larynx member, a subvocalization machine learning module configured to process the subvocalization data to interpret a first set of user commands, a capacitive touch recognition surface configured to detect one or more gestures of the user. a gestural machine learning module configured to interpret the one more gestures as a second set of user commands, and a feedback device configured to provide real-time responses to the user, wherein the real-time responses include one or more of auditory, haptic, and/or visual feedback.

### FIELD OF THE DISCLOSURE

The present disclosure is generally related to enhancing AR and VR shopping experiences.

### BACKGROUND

Currently, users often struggle with seamless interaction and control in AR/VR environments due to the lack of intuitive and natural input methods, leading to a disjointed and less immersive experience. The complexity of navigating digital environments and accessing information or services is compounded by the limited ability to integrate multiple input types, such as voice, gestures, and subvocalizations, into a cohesive user interface. Also, ensuring secure and efficient processing of sensitive data, including user commands and financial transactions, is challenging in integrated systems that combine wearable devices, AR/VR technology, and cloud services. Users face difficulties in real-time responsiveness and accurate tracking within AR/VR spaces, which can diminish the quality of the experience and lead to user frustration. Lastly, the need for personalization and context-awareness in digital interactions often goes unmet, limiting the relevance and effectiveness of the information and services provided to users in augmented reality environments. Traditional methods of interacting with digital systems, such as touchscreens and physical controllers, are inadequate in AR/VR settings, where more immersive and hands-free interaction methods are required. Thus, there is a need in the prior art to enhance AR and VR shopping experiences.

### SUMMARY

The present disclosure overcomes the disadvantages of conventional approaches by providing a system and method for enhancing an augmented reality (AR) and/or virtual reality (VR) experience. According to one aspect, a system includes a larynx member comprising a piezoelectric sensing array configured to capture analog waveforms representing movements of a user's larynx muscles while subvocalizing and a processor configured to convert the analog waveforms into subvocalization data. The system also includes an AR/VR enhancement device comprising a communication interface configured to receive the subvocalization data from the larynx member, a subvocalization machine learning module configured to process the subvocalization data to interpret a first set of user commands, a capacitive touch recognition surface configured to detect one or more gestures of the user, a gestural machine learning module configured to interpret the one more gestures as a second set of user commands, and a feedback device configured to provide real-time responses to the user, where the real-time responses include one or more of auditory, haptic, and/or visual feedback. The system further includes an AR/VR device comprising operatively connected to the AR/VR enhancement device, wherein the AR/VR device is configured to receive the first and second sets of commands to generate therefrom the AR and/or VR experience. In addition, the system includes an application module configured to facilitate an online transaction.

In some embodiments, the larynx member includes an escape channel for expelling excess ultrasound gel applied to a surface of the larynx member and a neck of the user, the ultrasound gel configured to facilitate transmission of vibrations from the user's larynx to the piezoelectric sensing array.

In some embodiments, the larynx member further includes an accelerometer configured to determine an orientation and/or a movement of the larynx of the user, wherein the processor is further configured to distinguish, based on input from the accelerometer, whether the user is speaking or performing other movements.

In some embodiments, the capacitive touch recognition surface is radar enhanced to detect gestures in free space.

In some embodiments, the AR/VR enhancement device is one of a wearable device, a smartphone, or a tablet.

In some embodiments, the system further includes an integration module configured to aggregate data from the AR/VR enhancement device, the larynx member, and the AR/VR device within a cloud environment and synchronize the data from the AR/VR enhancement device, the larynx member, and the AR/VR device in time and context before the AR and/or VR experience is generated by the AR/VR device.

In some embodiments, the method further includes a transaction module communicatively coupled to the application module and configured to facilitate a transaction in response to the first or second sets of commands indicating a user interaction to make a purchase.

In some embodiments, the subvocalization machine learning module is configured to compare the subvocalization data with a pre-established training set.

In some embodiments, the subvocalization machine learning module and/or the gestural machine learning module comprises an artificial intelligence (AI) and/or machine learning (ML) model including at least one of a large language model (LLM), convolutional neural network (CNN), recurrent neural network (RNN), support vector machine (SVM), random forest, hidden Markov model (HMM), autoencoder, principle component analyzer, Bayesian network, k-nearest neighbor algorithm, reinforcement learning algorithm, Gaussian mixture model, and/or a transfer learning model.

In some embodiments, the AR/VR enhancement device further includes at least one camera configured to track movements of the user and/or a position of the AR/VR device in space.

According to another aspect, a method for enhancing an augmented reality (AR) and/or virtual reality (VR) experience includes capturing, via a piezoelectric sensing array of a larynx member, analog waveforms representing movements of a user's larynx muscles while subvocalizing. The method also includes converting, via a processor, the analog waveforms into subvocalization data, and receiving, by an AR/VR enhancement device, the subvocalization data from the larynx member. The method further includes processing, via a subvocalization machine learning module, the subvocalization data to interpret a first set of user commands. In addition, the method includes detecting, via a capacitive touch recognition surface, one or more gestures of the user. Further, the method includes interpreting, via a gestural machine learning module, the one more gestures as a second set of user commands. The method also includes providing real-time responses to the user via the AR/VR enhancement device, wherein the real-time responses include one or more of auditory, haptic, and/or visual feedback. The method additionally includes connecting an AR/VR device to the AR/VR enhancement device. Furthermore, the method includes receiving, by the AR/VR device from the AR/VR enhancement device, the first and second sets of commands to generate therefrom the AR and/or VR experience.

In some embodiments, the method further includes applying ultrasound gel to a neck of the user to facilitate transmission of vibrations from the user's larynx to the piezoelectric sensing array of the larynx member, the larynx member including an escape channel for expelling excess ultrasound gel.

In some embodiments, the method further includes determining by an accelerometer of the larynx member an orientation and/or a movement of the user's larynx and distinguishing, based on input from the accelerometer, whether the user is speaking or performing other movements.

In some embodiments, the capacitive touch recognition surface is radar enhanced to detect gestures in free space.

In some embodiments, the AR/VR enhancement device is one of a wearable device, a smartphone, or a tablet.

In some embodiments, the method further includes aggregating data from the AR/VR enhancement device, the larynx member, and the AR/VR device within a cloud environment and synchronizing the data from the AR/VR enhancement device, the larynx member, and the AR/VR device in time and context before the AR and/or VR experience is generated by the AR/VR device.

In some embodiments, the method further includes processing a transaction in response to the first or second sets of commands indicating a user interaction to make a purchase.

In some embodiments, the method further includes processing the subvocalization the subvocalization data includes compare the subvocalization data with a pre-established training set.

In some embodiments, the subvocalization machine learning module and/or the gestural machine learning module comprises a machine learning model including at least one of a large language model (LLM), convolutional neural network (CNN), recurrent neural network (RNN), support vector machine (SVM), random forest, hidden Markov model (HMM), autoencoder, principle component analyzer, Bayesian network, k-nearest neighbor algorithm, reinforcement learning algorithm, Gaussian mixture model, and/or a transfer learning model.

In some embodiments, tracking movements of the user and/or a position of the AR/VR device in space via at least one camera within the AR/VR enhancement device.

### BRIEF DESCRIPTION OF THE DRAWINGS

FIG. 1 is a schematic diagram of a system for enhancing AR and VR shopping experience, according to an embodiment.

FIG. 2 is a flowchart of a method performed by a Voice Module, according to an embodiment.

FIG. 3 is a flowchart of a method performed by a Gesture Module, according to an embodiment.

FIG. 4 is a flowchart of a method performed by an Interaction Module, according to an embodiment.

FIG. 5 is a flowchart of a method performed by a Capture Module, according to an embodiment.

FIG. 6 is a flowchart of a method performed by an Integration Module, according to an embodiment.

FIG. 7 is a flowchart of a method performed by an Interface Module, according to an embodiment.

FIG. 8 is a flowchart of a method performed by a Transaction Module, according to an embodiment.

FIG. 9 is a flowchart of a method performed by an AR Module, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

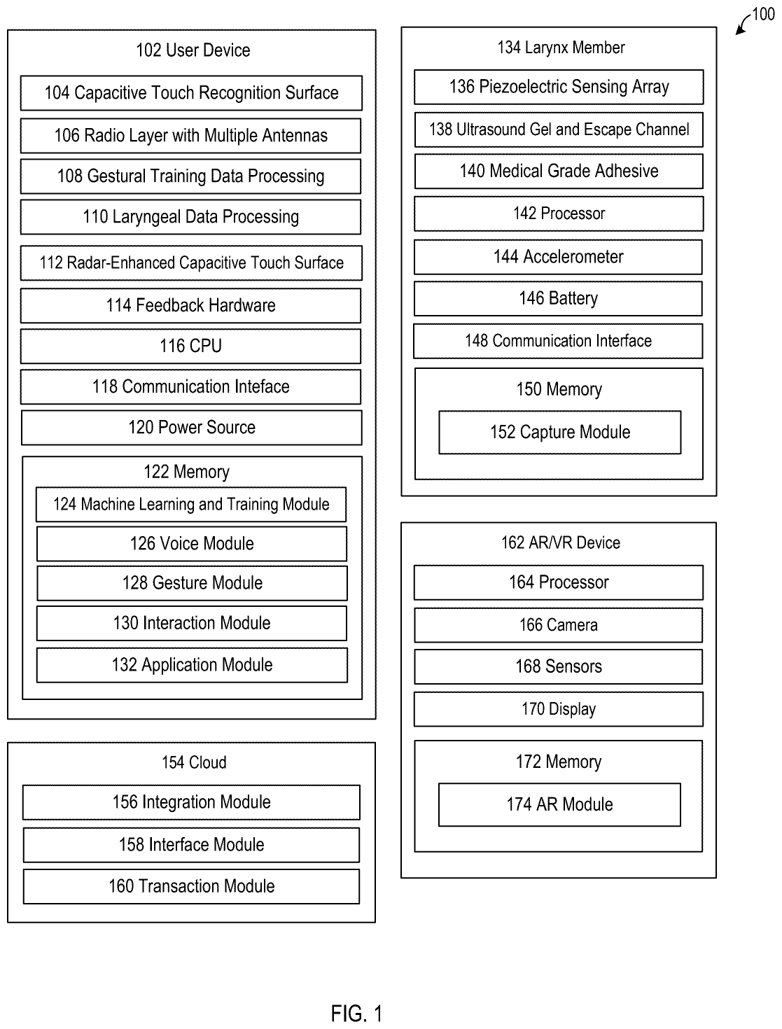

FIG. 1 illustrates schematic diagram of a system 100 for enhancing AR and VR shopping experiences. This system 100 comprises a user device 102, which may be a wearable gadget and may serve as a central hub for processing data, facilitating communication, and providing seamless user interaction. The user device 102 may be a wearable device or smartphone, tablet, or the like. The user device 102 may include a CPU 116 that manages and executes various functions, from running applications to processing data from the device's sensors. In some embodiments, the user device 102 may contain a display that provides a clear and vibrant interface for viewing information, notifications, and interactive elements. In some embodiments, the display may include a capacitive touch recognition surface 104, allowing users to interact with the user device 102 through touch and gestures, offering a natural and intuitive way to navigate menus, control settings, and access features. In some embodiments, the user device 102 may connect to a larynx member 134, which captures subvocalizations, such as silent or near-silent speech generated by the movements of the larynx muscles. In some embodiments, the larynx member 134 may include a piezoelectric sensing array 136 to detect the subtle movements of the neck muscles and then are processed by the user device's 102 machine learning and training module 124 to interpret user commands. In some embodiments, the user device 102 may include a plurality of connectivity options, such as Bluetooth and Wi-Fi, ensuring seamless communication with other devices and systems. The user device 102 may connect to smartphones, tablets, and other wearables, allowing for synchronized notifications, data sharing, and extended functionality. In some embodiments, the user device 102 may support cloud 154 integration, enabling users to access online services, store data securely, and perform actions like online shopping or navigation with voice commands and gesture inputs. In some embodiments, the user device 102 may pair or connect to a user's smartphone or mobile device through a plurality of communication channels, including but not limited to Wi-Fi, Bluetooth, USB cables, etc. In some embodiments, the user device 102 may receive commands inputted by the user on their smartphone or mobile device. In some embodiments, the system may be designed with a distributed architecture that encompasses processing capabilities, file storage, hosting, and file transfers. In some embodiments, the systems may be interconnected through a wireless mesh network. In some embodiments, the system's processing and computational tasks may be distributed across multiple devices within the network, allowing each device to contribute to the overall computational power of the network. In some embodiments, devices with spare processing capacity may offer their resources to others, enhancing the system's efficiency and performance. In some embodiments, data storage may be managed through a sharding mechanism, where files are divided into smaller pieces and stored across various devices within the network. In some embodiments, the system may utilize a wireless mesh network routing protocol, allowing devices to communicate directly with each other. In some embodiments, the system may aggregate data from multiple devices, offering a richer and more detailed dataset to each user. For example, information from ten devices within range can be pooled, providing a collective data resource that enhances the accuracy and depth of information available. In some embodiments, devices that are not currently utilizing their full processing power may opt-in to share their computational capabilities with other devices in the network to ensure that the network's overall processing power is efficiently utilized, optimizing performance for demanding tasks. In some embodiments, the system may integrate with other mobile phones, computers, IoT devices, and base stations. In some embodiments, the mesh network and distributed processing framework may facilitate real-time data sharing and processing.

In some embodiments, the user device 102 may connect to a base station, which may receive signals, process data, and provide accurate tracking of devices detected within an area. In some embodiments, the base station may comprise a phased array antenna, power source, CPU, NIC, RF power meter, sub-nanosecond clock, wireless network controller, Bluetooth controller, ethernet port, memory, and camera. In some embodiments, the phase array antenna captures signals from multiple devices, and the signal processing module employs algorithms to extract tracking information from the signals. In some embodiments, the processed data may be used to generate comprehensive situational awareness, which can be leveraged for applications like real-time tracking, security monitoring, or AR experiences. In some embodiments, the base station may include a synthetic aperture radar system. In some embodiments, the system may incorporate the data from the base station, such as the SAR data, tracking data, and/or camera data, camera data from 3rd parties, such as a nearby property if available, sensor data from vehicles, robots, drones, etc. internet search from a computer nearby, data from other user devices 102, larynx members 134, and/or AR/VR devices 162, etc. that are part of the distributed network. For example, if a user asks about a man in a red shirt via subvocalization, asking the AI assistant if he has a LinkedIn profile, the system may use facial recognition from an onboard or nearby third-party camera to identify him. In some embodiments, the system may alternatively use a device ID of the phone in the man's pocket, detected and tracked by the base station, to gather the information.

Further, embodiments may include a capacitive touch recognition surface 104, which provides a responsive interface for touch and gesture inputs. The capacitive touch recognition surface 104 may operate using capacitive sensing technology, which detects changes in the electrical field caused by the user's touch or proximity of conductive objects, such as fingers or a stylus. In some embodiments, the capacitive touch recognition surface 104 may be augmented with a radar-enhanced sensing system that allows for the precise detection of touch points as well as hand movements above and around the surface. The capacitive touch recognition surface 104 may comprise a grid of capacitive sensors that measure the exact location and pressure of touches on an X or Y plane. In some embodiments, the radar component beneath the surface may emit radio pulses that reflect off the user's hand, allowing the user device 102 to determine the distance to the hand and any objects in front of it, effectively adding a third dimension, for example, a Z-axis, to the interaction. In some embodiments, the radar component may enable the touch surface to recognize gestures made in free space, such as swiping, pointing, or hovering, without direct contact. In some embodiments, the surface may be designed to distinguish between different types of gestures, including those that involve multiple fingers. In some embodiments, the capacitive touch recognition surface 104 may detect the direction of nearby signals, facilitating interactions with other devices in the vicinity, such as pairing, navigation, or initiating specific actions based on the user's gestures. In some embodiments, the radar-enhanced functionality allows the device to identify and interpret complex gestures and commands, which can be customized and programmed by the user or developers.

Further, embodiments may include a radio layer with multiple antennas 106, which may consist of an array of antennas designed to capture and process wireless signals from various sources. In some embodiments, the antennas may be capable of receiving and transmitting signals across multiple frequencies, enabling the device 102 to interact seamlessly with other devices and networks. In some embodiments, the antennas may be designed to perform various functions, such as detecting the direction and strength of incident wireless signals, which is useful for tasks like device-to-device communication, gesture recognition, and environmental scanning. In some embodiments, the system may use the radio data to enhance the device's 102 situational awareness, allowing it to understand the presence and location of nearby devices, which may be used for augmented reality applications. In some embodiments, the radio layer 106 may incorporate low observable tracking techniques and phased-array antenna systems, which may identify the origin of incoming signals and adjust the device's 102 responses accordingly. In some embodiments, the tracking techniques and phased-array antenna system may improve connectivity and signal quality and enhance security by steering signals in specific directions and reducing interference.

Further, embodiments may include a gestural training data processing 108 system, which may enable accurate and responsive gesture-based interactions. The gestural training data processing 108 may utilize machine learning algorithms to analyze and interpret user gestures, which are detected through a combination of sensors, including the capacitive touch recognition surface 104, the radar-enhanced components of the device 102 (e.g., SAR), and/or a camera. In some embodiments, the gestural training data processing 108 system may recognize specific gestures by comparing real-time data against a set of training data that has been pre-processed and stored. For example, the device 102 may capture raw data from the user's movements, which may include finger swipes, taps, or more complex hand motions. The raw data is then processed to identify various features, such as the trajectory, speed, and intensity of the movements. The gestural training data, which comprises examples of various gestures, may serve as a reference framework. In some embodiments, the gestural training data processing 108 may continuously improve its accuracy by learning from both the pre-existing dataset and new inputs provided by the user. In some embodiments, The gestural training data processing 108 may prompt the user to perform certain gestures multiple times to refine its understanding and enhance the reliability of gesture recognition during the training phase. In some embodiments, the machine learning algorithms may analyze patterns in the data, distinguishing between different gestures and reducing the likelihood of false positives. In some embodiments, the gestural training data processing 108 may become adept at distinguishing subtle variations in gestures over time as the system accumulates more data and refines its models, adapting to the unique mannerisms of individual users.

Further, embodiments may include a laryngeal data processing 110 system, which may capture and interpret subvocalizations, such as silent or near-silent speech sounds produced by the movements of the larynx. The laryngeal data processing 110 may enable voice-activated control and communication without the need for audible speech. In some embodiments, the larynx member 134 may be equipped with a piezoelectric sensing array. The array captures the minute vibrations and muscle movements in the user's throat as they subvocalize or perform silent speech. The larynx member 134 may use an ultrasound gel and an escape channel to maintain proper contact with the skin to ensure accurate data capture by preventing air pockets that could interfere with the signal. The ultrasound gel may be stored in a reservoir within the larynx member and/or applied from an external source. In some embodiments, the raw analog waveforms representing the laryngeal movements may be captured by the larynx member 134, and the data is transmitted to the user device 102. The laryngeal data processing 110 system may employ machine learning algorithms to analyze the captured data, converting the waveforms into digital signals that can be processed further. The laryngeal data processing 110 may recognize specific subvocal commands by comparing the incoming data against a pre-established training set. In some embodiments, the training set may consist of various subvocal patterns that the laryngeal data processing 110 system has learned to associate with specific commands or actions. In some embodiments, the machine learning model may continuously refine its accuracy through iterative training, learning to distinguish between different subvocalizations and adapting to the user's unique vocal patterns. In some embodiments, the laryngeal data processing 110 system may interpret more complex vocal patterns, including intonations and inflections, which might indicate different intentions or nuances in commands, which may provide a more natural and intuitive user interface, where the user can interact with the device 102 or control connected systems using a variety of vocal inputs. In some embodiments, the laryngeal data processing 110 system may be integrated with other applications, such as AR/VR environments, to facilitate seamless control through subvocal commands enabling functionalities like silent phone calls, navigation assistance, and even interaction with online shopping platforms, where users can issue commands like “add to cart” or “checkout” without speaking aloud.

Further, embodiments may include a radar-enhanced capacitive touch surface 112, which may be an input interface integrated into the user device 102 that is designed to enhance user interaction through precise touch and gesture recognition. The radar-enhanced capacitive touch surface 112 may combine traditional capacitive sensing technology with radar-based detection to offer a multi-dimensional input method that surpasses standard touchscreens. In some embodiments, the capacitive touch recognition surface 104 may function by detecting changes in the electrical field when a user's finger or another conductive object comes into contact with it, allowing the device 102 to accurately identify touch points on the X and Y axes, enabling functionalities like taps, swipes, and multi-touch gestures. In some embodiments, the integration of radar technology adds a third dimension, the Z-axis, to the interaction. In some embodiments, a radar sensor underneath the capacitive grid emits high-frequency radio waves that reflect off objects, such as the user's hand or fingers, and by analyzing these reflections, the system may determine not only the location of the touch but also the distance and movement of the hand above the surface. In some embodiments, the radar-enhanced capacitive touch surface 112 enables the device 102 to detect gestures made in free space, such as hovering, pointing, or making specific hand signs, even without direct contact with the surface. In some embodiments, users may perform complex gestures, such as pinch-to-zoom or swiping in mid-air, which are recognized with greater accuracy and responsiveness. The radar-enhanced capacitive touch surface 112 may distinguish between intentional gestures and accidental touches, minimizing input errors and enhancing the overall user experience. In some embodiments, the radar-enhanced capacitive touch surface 112 may be used to interact with the device's 102 environmental awareness features. For example, it may detect the presence and direction of other devices or objects in the vicinity, providing contextual information that enhances user interaction with the surrounding environment. In some embodiments, the radar-enhanced capacitive touch surface 112 may be used in AR/VR applications, where the system can recognize and respond to user gestures to manipulate virtual objects or navigate through virtual spaces.

Further, embodiments may include feedback hardware 114, which may provide real-time responses to the user, enhancing the interaction experience by delivering auditory, haptic, and potentially visual feedback. In some embodiments, the feedback hardware 114 may be designed to ensure that users receive immediate and clear confirmation of their inputs and actions, thus improving usability and accessibility. In some embodiments, the feedback hardware 114 may include an auditory feedback system that utilizes conventional headphones or speakers to deliver sound directly to the user. The audio feedback may include various types of audio cues, such as voice confirmations, alerts, or other sounds that inform the user about the successful recognition and execution of commands, navigation prompts, or system notifications. In some embodiments, the feedback hardware 114 may include haptic feedback. It may generate vibrations or physical sensations that users can feel, providing a tactile response to their interactions with the device. For example, when a user performs a gesture or issues a subvocal command, the device 102 may vibrate gently to indicate that the input has been registered and processed. In some embodiments, the feedback hardware 114 may include visual feedback, which may be provided through connected displays or AR/VR device 162 systems. It may include visual confirmations on screens or augmented reality overlays that guide users through their interactions or provide additional information.

Further, embodiments may include a central processing unit, or CPU 116, which may coordinate and execute a wide array of functions critical to the user device's 102 operations. The CPU 116 may handle the computational tasks required to process the data from various sensors and interfaces, including the piezoelectric sensing array 136, capacitive touch recognition surface 104, and other input mechanisms. In some embodiments, the CPU 116 may be responsible for processing the raw data captured by the piezoelectric sensing array 136 in the larynx member 134. In some embodiments, the processing may involve converting the analog signals generated by subvocalizations into digital data that may be analyzed and interpreted. In some embodiments, the CPU 116 may perform machine learning algorithms that have been trained to recognize specific patterns within the raw data, allowing the user device 102 to accurately identify and execute the user's intended commands, which may include filtering out noise, distinguishing between similar signals, and adapting to the unique subvocalization patterns of different users. In some embodiments, the CPU 116 may manage data from the capacitive touch recognition surface 104 and other input sensors. In some embodiments, the CPU 116 may interpret gestures and touch inputs, converting these into actionable commands within the user device's 102 operating system. For example, the CPU 116 may recognize a swipe gesture as a command to navigate through a menu or a tap as a selection input. In some embodiments, the CPU 116 may process three-dimensional data from the radar-enhanced capacitive touch surface 112 to interpret gestures made in free space, such as hovering or directional swipes. In some embodiments, the CPU 116 may handle data transmission between the user device 102 and cloud 154 based servers, which might be used for further processing or storage of data. In some embodiments, the CPU 116 may ensure secure communication protocols are followed to maintain the integrity and privacy of user data, such as in applications involving sensitive information like financial transactions or personal communications. In some embodiments, the CPU 116 may coordinate the user device's 102 feedback systems, including auditory and haptic feedback. The CPU 116 may process and send the appropriate signals to these systems to provide real-time responses to the user, confirming actions or providing notifications.

Further, embodiments may include a communication interface 118, which provides interaction with other devices, networks, and external systems. The communication interface 118 may facilitate the transmission and reception of data, supporting various applications ranging from simple notifications to complex interactions in AR environments. In some embodiments, the communication interface 118 may include multiple wireless communication modules, such as Wi-Fi, Bluetooth, and cellular connectivity. In some embodiments, Wi-Fi may enable the user device 102 to connect to local networks and the internet, allowing it to access cloud 154 based services, update software, and interact with online platforms. In some embodiments, Bluetooth connectivity may provide a short-range wireless link to other Bluetooth-enabled devices, including headphones for auditory feedback, smartphones for notifications and data synchronization, and other wearable devices. In some embodiments, cellular modules may provide access to mobile networks, enabling functionalities such as telephony, messaging, and internet access independent of Wi-Fi. In some embodiments, the communication interface 118 may support multi-modal interactions, enabling the user device 102 to function as a central hub in a connected ecosystem, allowing for seamless integration with external sensors, AR/VR devices 162, and other smart devices, facilitating a cohesive and interactive user experience.

Further, embodiments may include a power source 120, which may be a high-capacity rechargeable battery designed to provide sufficient energy to support the user device's 102 features, including data processing, communication, and sensor operation. In some embodiments, the power source 120 may be a battery, such as lithium-ion, allowing the user device 102 to operate for extended periods without requiring frequent charging. In some embodiments, the power source 120 may be designed to include safety features to prevent overcharging, overheating, and other issues that may compromise the user device's 102 performance or safety. In some embodiments, the power source 120 may include power management circuitry that monitors the power source's 120 charge level and optimizes the distribution of power to various components, such as the CPU 116, sensors, feedback systems, and communication modules. In some embodiments, the power source 120 may support a plurality of charging methods, such as a USB-C port or similar interface for wired charging, allowing for quick and easy recharging from standard power outlets or other USB-enabled power sources. In some embodiments, the user device 102 may support wireless charging technologies, which enable users to charge the user device 102 by placing it on a compatible charging pad. This feature is particularly useful for maintaining device readiness without the need for cumbersome cables.

Further, embodiments may include a memory 122, which may be responsible for storing data, software, and operational instructions necessary for the user device 102 to function. In some embodiments, the memory 122 may be a volatile memory, such as random access memory or RAM, which provides temporary storage for data that the CPU 116 actively uses while performing tasks. In some embodiments, the data may include data related to running applications, system processes, and active user interactions, such as processing subvocalizations, gestures, and other inputs, allowing for quick access and manipulation of data, which is useful for the device's real-time processing capabilities and responsiveness. In some embodiments, the memory 122 may include non-volatile memory, such as storage, which may be used for long-term data storage and may include flash memory. The memory 122 may store the user device's 102 operating system, applications, user settings, and other persistent data. In some embodiments, the non-volatile memory 122 may ensure that important data is retained even when the device is powered off, allowing users to access their stored information, such as profiles, settings, and recorded interactions, whenever needed. In some embodiments, the non-volatile memory 122 may hold the training vectors used in the machine learning algorithms, which are critical for accurately interpreting subvocalizations and gestures. In some embodiments, the memory 122 may be designed to support the user device's 102 multitasking capabilities, allowing it to handle various functions simultaneously, such as real-time data processing, running multiple applications, and maintaining connectivity with external devices.

Further, embodiments may include a machine learning and training module 124, which may enhance the accuracy and efficiency of interpreting subvocalizations and gestures. The machine learning and training module 124 may assist the device 102 to accurately recognize and respond to a wide range of user inputs, adapting over time to individual user patterns and behaviors. The machine learning and training module 124 may use training vectors, which are generated from the unique subvocalization patterns and gestures of each user. The vectors may serve as reference points which allows the system to compare new inputs against previously learned data. In some embodiments, when a user first begins using the device 102, they may go through a training phase where they perform a series of subvocalizations and gestures. In some embodiments, the system may capture these inputs, convert them into digital signals, and process them to create an initial set of training vectors. The process may involve capturing detailed characteristics of the inputs, such as frequency, amplitude, and movement patterns, which are then stored for future reference. In some embodiments, the machine learning and training module 124 may utilize ultrasound imagery processing to interpret subvocalizations. The piezoelectric sensing array 136 in the larynx member 134 may capture analog waveforms representing the movements of the larynx muscles. The waveforms may be converted into depth maps or three-dimensional representations of the muscle movements. The machine learning algorithms may then analyze these maps to identify specific subvocalization patterns and convert them into training data that the system can use to improve its recognition capabilities. In some embodiments, the training process may be a continuous cycle where the system refines its understanding of the user's inputs. For example, as users continue to interact with the device 102, the machine learning and training module 124 updates its training vectors based on new data, enhancing the system's accuracy over time. In some embodiments, adaptive learning allows the device 102 to better handle variations in user input, such as changes in subvocalization tone or gesture style and reduces the likelihood of misinterpretation. In some embodiments, the machine learning and training module 124 may identify nuanced inputs, such as emotional tone in subvocalizations or subtle variations in gestures, allowing for a more natural and intuitive user experience, as the device 102 may respond to more implicit cues from the user. In some embodiments, the machine learning and training module 124 may utilize a machine learning model including at least one of a large language model (LLM), convolutional neural network (CNN), recurrent neural network (RNN), support vector machine (SVM), random forest, hidden Markov model (HMM), autoencoder, principle component analyzer, Bayesian network, k-nearest neighbor algorithm, reinforcement learning algorithm, Gaussian mixture model, and/or a transfer learning model. In some embodiments, the training process may include the user reading various prompts or phrases in combination with the AI/ML models. In some embodiments, the training process may have the user to wear the larynx member 134, which may include a microphone, and the user's speech and vibrations may be collected and correlated by the system to learn and identify vibration patterns over time.

Further, embodiments may include a voice module 126, which connects the user device 102 with the larynx member 134 to establish a secure communication link. The voice module 126 may continuously poll the larynx member 134 for raw subvocalization data. The voice module 126 processes the received subvocalization data by applying signal processing and machine learning techniques to interpret the subvocalizations into understandable commands or text. The processed output is sent to the interaction module 130. The process may operate in a continuous loop to ensure real-time data capture, interpretation, and response based on the user's silent speech commands.

Further, embodiments may include a gesture module 128, which may be responsible for capturing, processing, and interpreting user gestures. The gesture module 128 may activate various sensors, such as accelerometers, gyroscopes, etc., to capture detailed gesture data. The gesture data is then processed through data cleaning, feature extraction, and comparison against a database of pre-existing training data. The gesture module 128 recognizes and classifies the gestures using machine learning algorithms, taking into account contextual factors to ensure accurate interpretation. The interpreted gestures are sent to the interaction module 130, and the process returns to capturing the gesture data. In some embodiments, the gesture module 128 may incorporate radar sensor data, such as data from a SAR, ultrasonic, etc.

Further, embodiments may include an interaction module 130, which may receive and process outputs from the voice module 126 and gesture module 128. The interaction module 130 connects to the integration module 156. The interaction module 130 continuously receives interpreted data from the voice module 126, which captures subvocal commands, and from the gesture module 128, which captures physical movements. The interaction module 130 validates, parses, and synthesizes the data into actionable commands, which are transmitted to the integration module 156 for further execution.

Further, embodiments may include an application module 132, which may include allowing the user device 102 to serve as a central tool for communication, navigation, entertainment, etc. In some embodiments, the application module 132 may include communication tools that enable the user to stay connected through various mediums, including support for traditional telephony, allowing users to make and receive phone calls directly from the user device 102. In some embodiments, the application module 132 may include messaging services, such as SMS, email, and instant messaging platforms, etc. The user device 102 may handle the interactions through conventional means or through subvocalization, in which the larynx member 134 captures silent speech for discreet communication. In some embodiments, the application module 132 may include navigation features, leveraging GPS and other location-based technologies to provide real-time directions and location services. In some embodiments, the application module 132 may integrate AR features, overlaying navigation instructions directly onto the user's field of view, enhancing the experience with visual cues and real-world context. In some embodiments, the application module 132 may include functionalities for online shopping and instant purchases, providing a convenient platform for users to browse and buy products. The application module 132 may include features integrated with secure payment systems, allowing users to complete transactions directly from the user device 102. In some embodiments, the application module 132 may interact with AR/VR device 162 to provide immersive shopping experiences where users can view virtual representations of products, read reviews, and access detailed information. In some embodiments, the system may handle secure transactions using voice commands, gestures, or traditional input methods, ensuring a smooth and secure shopping process. In some embodiments, the application module 132 may be equipped with tools designed to support users with medical or accessibility needs, including assisting with managing health conditions, such as monitoring vital signs or providing medication reminders. The application module 132 may enhance accessibility, such as voice-activated controls, text-to-speech capabilities, and screen readers, providing functions for users with disabilities. In some embodiments, the application module 132 may include media playback for music, videos, and streaming services. In some embodiments, the application module 132 may connect to external displays or speakers, providing a comprehensive multimedia experience. In some embodiments, the application module 132 may include applications for gaming, such as traditional games and augmented reality games, leveraging the device's graphics and sensor capabilities. In some embodiments, the user may interact with these applications through touch, gestures, or voice commands, providing a versatile and engaging entertainment platform. In some embodiments, the application module 132 may include an AI/ML-powered personal assistant, leveraging technologies such as Large Language Models, Convolutional Neural Networks, etc. In some embodiments, the assistant may be designed to enhance user interaction by performing a wide range of tasks and providing contextual information seamlessly integrated into the user's AR experience. In some embodiments, the AI assistant may be customizable and adapt to individual user preferences and needs. In some embodiments, the AI assistant may use AI and ML techniques to learn from user interactions to provide personalized experiences. For example, the assistant may adjust settings, make phone calls, purchase goods, and handle any computer or mobile phone tasks. In some embodiments, the assistant may communicate with users naturally and contextually by using conversational language that feels like interacting with a human being, including changing settings on the device, managing schedules, sending messages, and more. In some embodiments, the assistant may understand complex commands and may perform multiple tasks simultaneously, providing a seamless user experience. In some embodiments, the AI assistant may be integrated with the AR/VR system's vision capabilities. The AI assistant may analyze real-time video feed from the AR/VR device's 162 cameras 166 to detect and interpret visual content, allowing the assistant to provide contextual information about the user's surroundings. For example, the AI assistant may identify landmarks, recognize objects, and detect movements, using this information to offer real-time guidance and assistance. In some embodiments, the AI assistant may provide advanced navigation and wayfinding capabilities by providing directions in a human-like manner, utilizing real-world objects and landmarks. For example, instead of saying, “Turn right in 100 meters,” the AI assistant might say, “See that green umbrella up ahead on your right-hand side? Walk towards it and then make a right when you reach it.” In some embodiments, the AI assistant may offer real-time assistance based on the environment. For example, it might say, “See the man walking about 5 feet in front of you, the one in the green and white striped t-shirt? Follow him until I direct you otherwise.” In some embodiments, users may adjust settings through simple voice commands. In some embodiments, the AI assistant may change device configurations, toggle features on and off, and personalize the AR experience based on user preferences. In some embodiments, the AI assistant may automate routine tasks, such as making phone calls, sending emails, and setting reminders. In some embodiments, the AI assistant may execute tasks quickly and efficiently, freeing up the user to focus on other activities by understanding natural language commands. In some embodiments, the AI assistant may facilitate online shopping and transactions. Users may instruct the assistant to purchase items, check prices, and apply discounts. In some embodiments, the assistant may ensure secure transactions by verifying user intentions and utilizing encrypted communication for payment processes. In some embodiments, the AI assistant may employ advanced ML techniques to continuously learn from user interactions, including reinforcement learning, where the system improves its responses based on feedback, and transfer learning, where it applies knowledge from one task to enhance performance on related tasks. In some embodiments, the AI assistant may utilize Large Language Modules to understand and generate human-like text, allowing the assistant to engage in meaningful conversations, understand complex instructions, and provide detailed responses. In some embodiments, Convolutional Neural Networks may enable the AI assistant to process visual data, such as recognizing objects and interpreting gestures.

Further, embodiments may include a larynx member 134, which may be a specialized interface device designed to capture and process subvocalizations, such as silent or near-silent speech produced by the movements of the larynx. The larynx member 134 may enable users to issue commands and interact with technology without the need for audible speech. In some embodiments, the larynx member 134 may be compact and designed to be affixed to the user's neck, where it can accurately detect the subtle muscle movements associated with subvocalizations. The larynx member 134 may include a piezoelectric sensing array 136, which captures the analog waveforms generated by the larynx muscles during subvocalization or silent speech. The waveforms contain the data necessary for interpreting the user's intended speech commands. In some embodiments, the larynx member 134 may use an ultrasound gel that facilitates proper contact with the skin that, prevents any air pockets that could distort the signal, and ensures accurate and reliable data capture. In some embodiments, an escape channel 138 may be incorporated into the design to allow any excess gel to escape, which maintains a clear interface between the sensing array and the skin. The larynx member may be secured to the user's neck using medical-grade adhesive 140, which ensures that it stays in place even with regular movement. The medical-grade adhesive 140 may have skin-friendly properties and durability, making it suitable for prolonged use. In some embodiments, the larynx member 134 may be positioned near the laryngeal nerve and the muscles that move during speech, allowing it to capture detailed subvocalization data accurately. The larynx member 134 may include a processor 142 and memory 150 to handle the initial stages of data processing. In some embodiments, the processor 142 may convert the analog signals from the piezoelectric array 136 into digital data, which is then analyzed using machine learning algorithms to recognize specific subvocal commands. In some embodiments, the processing may include filtering out noise and refining the signal to ensure that the subvocalizations are accurately interpreted. In some embodiments, the memory 150 may store training data and user-specific patterns, enabling the larynx member 134 to adapt and improve its recognition accuracy over time. In some embodiments, the larynx member 134 may include an accelerometer 144, which may detect the movements of the head and neck. In some embodiments, the accelerometer 144 may be able to distinguish between intentional subvocalizations and other movements, providing an additional layer of accuracy to the data interpretation. In some embodiments, the accelerometer 144 data may also be used to detect gestures made with the head, further expanding the device's input capabilities.

Further, embodiments may include a piezoelectric sensing array 136, which may be designed to capture the minute vibrations and movements of the larynx muscles during subvocalization or silent speech. The piezoelectric sensing array 136 may serve as the primary interface for detecting the physical signals associated with speech that are not audible but are still indicative of vocal intent. The piezoelectric sensing array 136 may operate by converting mechanical stress, such as the subtle muscle movements in the larynx region, into electrical signals, which are then processed to interpret the user's intended subvocalizations. The piezoelectric sensing array 136 may be composed of multiple piezoelectric sensors that are sensitive to changes in pressure and movement. For example, when the user subvocalizes, the larynx muscles generate slight vibrations and shifts, which are detected by the sensors in the array. In some embodiments, the sensors may be capable of capturing a wide range of frequencies and amplitudes, allowing them to accurately record the complex and varied signals produced by the laryngeal activity. In some embodiments, the piezoelectric sensing array 136 may be able to distinguish between different subvocalizations, as even minor differences in muscle movement can correspond to different intended commands or speech sounds. In some embodiments, the electrical signals generated by the piezoelectric sensing array 136 may be in an analog format, representing the varying levels of mechanical stress detected. The signals may then be processed by the larynx member's 134 processor 142, where they are converted into digital data for further analysis. In some embodiments, the data processing may involve filtering and amplifying the signals to enhance their clarity and ensure that the system's machine-learning algorithms can accurately interpret them. In some embodiments, the algorithms may be trained to recognize specific patterns within the data that correspond to different subvocalizations, allowing the system to accurately identify the user's intended commands or speech.

Further, embodiments may include ultrasound gel and escape channel 138, which may be designed to ensure optimal performance of the piezoelectric sensing array 136 in detecting subvocalizations. The ultrasound gel may provide a clear and uninterrupted transmission of mechanical vibrations from the user's larynx to the piezoelectric sensors. The ultrasound gel may serve as an intermediary medium that enhances the contact between the sensors and the skin to provide accurate detection of the minute muscle movements associated with silent speech. The ultrasound gel may be applied to the skin area where the larynx member 134 is affixed, creating a conductive layer that fills any gaps or irregularities between the skin and the device. The layer may eliminate air pockets that may interfere with the transmission of mechanical signals. Air pockets act as barriers to mechanical vibrations, leading to signal attenuation and distortion. By using the gel, the system ensures that the maximum amount of vibrational energy is transferred to the piezoelectric sensors, thereby improving the sensitivity and accuracy of the signal detection. The escape channel 138 complements the use of ultrasound gel by providing a pathway for any excess gel to be expelled. The escape channel 138 may prevent the accumulation of gel in areas where it is not needed, which may lead to slippage or an uneven interface between the device and the skin. In some embodiments, the escape channel 138 may ensure that only the necessary amount of gel remains in contact with the skin. In contrast, the excess gel is guided away from the sensitive sensing areas. This not only maintains the integrity of the sensor-skin interface but also prevents the potential buildup of gel that could interfere with the device's adhesion or user comfort.

Further, embodiments may include a medical grade adhesive 140, which may be designed to securely affix the device to the user's neck, ensuring consistent and reliable contact with the skin. The medical grade adhesive 140 may maintain the stability and position of the piezoelectric sensing array 136, which may be responsible for capturing the subvocalizations. In some embodiments, the medical grade adhesive 140 may meet the standards for biocompatibility, ensuring that it is safe for prolonged contact with human skin. In some embodiments, the medical grade adhesive 140 may be formulated to minimize the risk of skin irritation or allergic reactions, making it suitable for users with sensitive skin or those who need to wear the device for extended periods. In some embodiments, the medical grade adhesive 140 may be designed to maintain a secure bond even under conditions of movement or moisture, such as perspiration, to ensure that the larynx member 134 remains in place during typical daily activities, including speaking, turning the head, or even light physical exertion. The medical grade adhesive 140 may maintain the position of the device to ensure that the piezoelectric sensing array 136 consistently captures accurate data from the larynx muscles. In some embodiments, the medical grade adhesive 140 may maintain the quality of the data captured by the larynx member 134 by keeping the larynx member 134 firmly in place to ensure that the piezoelectric sensors have optimal contact with the skin to detect the subtle vibrations and movements associated with subvocalizations.

Further, embodiments may include a processor 142, which may be designed to handle the initial stages of data processing for the larynx member 134. The processor 142 may convert the analog signals captured by the piezoelectric sensing array 136 into digital data that can be further analyzed and interpreted. The analog signals, which represent the physical activity of the muscles, are inherently variable and complex. The processor 142 may digitize these signals by converting them into a form that can be used for further processing and analysis. It may involve applying analog-to-digital conversion techniques, where the continuous analog signals are sampled at specific intervals and quantized into digital values. In some embodiments, the processor 142 may perform initial filtering and preprocessing tasks, including noise reduction, which is useful for removing any irrelevant or extraneous signals that could interfere with accurate subvocalization recognition. In some embodiments, the processor 142 may standardize the data, adjusting for variations in signal strength and frequency to ensure consistent and reliable input for subsequent analysis. In some embodiments, the processor 142 may also execute machine learning algorithms that are trained to recognize specific patterns in the digitized signals corresponding to different subvocal commands or phrases. In some embodiments, the processor may perform the algorithms locally, allowing the larynx member to quickly and efficiently identify and respond to user inputs without needing to rely on external processing resources. In some embodiments, the processor 142 may manage data storage and transmission tasks by coordinating with the memory 150 components of the larynx member 134 to store user-specific training data and any other relevant information and facilitate the secure transmission of data to the main user device or other connected systems, using secure communication protocols to protect sensitive information.

Further, embodiments may include an accelerometer 144, which may detect and interpret the user's movements, such as head and neck movements, and provide additional data to distinguish between intentional subvocalizations and other physical actions. The accelerometer 144 measures the acceleration forces that are applied to the larynx member 134, which can result from various movements such as nodding, shaking, or tilting the head. In some embodiments, the accelerometer 144 may determine the orientation and movement of the larynx member 134 to identify when the user is engaging in specific actions that might accompany subvocalizations, such as head nods or tilts, which can indicate different meanings or commands. For example, a nod could be used to confirm a command, while a shake might indicate negation or cancellation. In some embodiments, the accelerometer 144 may enhance the accuracy of the system by providing additional context to the piezoelectric sensing array 136 data, which captures the vibrations and movements of the larynx muscles, and the accelerometer 144 tracks the overall motion of the device, allowing the system to filter out noise or unintended movements. For example, the accelerometer 144 may allow the system to distinguish between a subvocalization and a similar movement caused by external factors, such as walking or talking. In some embodiments, the accelerometer 144 contributes to the system's ability to understand complex user interactions, such as in AR applications that require a high degree of precision. By accurately detecting and interpreting head and neck movements, the system may provide a more responsive and intuitive user experience, enabling users to interact with digital content or physical devices naturally and seamlessly.

Further, embodiments may include a battery 146, which provides the necessary power to operate the larynx member's 134 sensing and processing systems. In some embodiments, the battery 146 may be a high-density lithium-ion or lithium-polymer type, allowing the battery 146 to deliver a stable and consistent power output to maintain the reliable operation of the larynx member 134, processor 142, sensors, and communication modules. In some embodiments, the battery 146 may include safety features that protect against common issues such as overcharging, overheating, and short-circuiting. In some embodiments, the battery 146 may include a battery management system, or BMS, that is integrated into the larynx member 134 and monitors the battery's 146 state of charge, temperature, and overall health, automatically adjusting the power usage to optimize performance and extend the battery's lifespan.

Further, embodiments may include a communication interface 148, which may enable the seamless transfer of data between the larynx member 134 and the user device 102 or other connected systems. The communication interface 148 is designed for efficiency, providing the efficient and secure transmission of the data captured by the larynx member 134, including the sensitive analog waveforms representing subvocalizations. In some embodiments, the communication interface 148 may include Bluetooth connectivity allowing for the continuous streaming of data without significant power consumption, ensuring that the user device 102 may operate for extended periods on a single charge, making it practical for daily use. In some embodiments, the communication interface 148 may support standard data encryption protocols to secure the data being transmitted, protecting it from interception or unauthorized access. In some embodiments, the communication interface 148 may include a USB-C port or other wired connections, which may provide charging the larynx member 134 and data transfer. In some embodiments, the communication interface 148 may include near-field communication, or NFC, which is a low-power, short-range, wireless technology that may facilitate quick and secure communication between devices. The communication interface also potentially includes a USB-C port or similar wired connection, which serves dual purposes: charging the device and enabling data transfer. This wired connection is particularly useful for initial device setup, firmware updates, or situations where a stable and high-speed data transfer is required. The USB-C port provides a robust and versatile interface that can handle both power delivery and data communication, ensuring that the device can be quickly recharged and data can be securely transferred to the user device or other systems. In some embodiments, the communication interface's 148 may ensure that the larynx member 134 may transmit captured data efficiently and securely, including sending the digitized subvocalization data to the main user device 102, transmitting to cloud 154 based systems for further analysis or storage, depending on the application.

Further, embodiments may include a memory 150, which may be responsible for storing various types of data and instructions for the operation of the user device 102, including capturing and processing subvocalizations. The memory 150 may be a non-volatile memory, such as flash memory, which retains stored data even when the device is powered off, to ensure that important information is not lost between uses. In some embodiments, the non-volatile memory may store the larynx member's 134 firmware, including the operating system and software that controls the larynx member's 134 functions. In some embodiments, the memory 150 may include user-specific data, such as training vectors and other machine learning data. In some embodiments, the training vectors may be generated during the initial setup and subsequent use of the larynx member 134, capturing unique subvocalization patterns of the user. In some embodiments, the machine learning algorithms may use the vectors to improve the accuracy of recognizing and interpreting subvocal commands over time. In some embodiments, the memory 150 may be a volatile memory, such as RAM, which may be used for temporary storage of data that the processor 142 needs to access quickly while performing tasks. In some embodiments, the RAM may support the real-time processing of subvocalization data, holding intermediate data and results. At the same time, the larynx member 134 converts analog signals from the piezoelectric sensing array 136 into digital formats and analyzes them. In some embodiments, the memory 150 may support secure data handling, including encrypting sensitive data, such as personal subvocalization patterns and secure commands, to protect against unauthorized access or tampering.

Further, embodiments may include a capture module 152, which may pair the larynx member 134 with the user device 102 to establish a wireless connection. The capture module 152 is designed for real-time data processing, as it activates the piezoelectric sensing array 136 to capture raw data from the user's subvocalizations and convert the signals into digital form. This real-time processing ensures that the captured data is transmitted to the user device 102 for further processing without delay, and the cycle repeats continuously to provide real-time data for applications such as communication and interaction in AR/VR environments, keeping the user engaged and in control.

Further, embodiments may include a cloud 154, which may serve as the central hub for processing, storage, and communication and contains the integration module 156, interface module 158, and transaction module 160. The integration module 156 may be responsible for aggregating the data from the user device 102, larynx member 134, and AR/VR device 162. The interface module 158 may apply algorithms and decision-making frameworks to determine the appropriate actions based on the received inputs. The transaction module 160 may interface with payment gateways, authentication services, and secure databases to process transactions initiated by the user, such as online shopping or service subscriptions. The cloud 154 may incorporate robust data storage solutions, using databases and storage systems optimized for speed, security, and redundancy.

Further, embodiments may include an integration module 156, which may be responsible for aggregating data from various sources, including the user device 102, larynx member 134, and AR/VR device 162. The integration module 156 may ensure that all data streams, whether they are subvocal commands, gesture inputs, or AR data, are accurately combined and processed. The integration module 156 may handle the synchronization of data, ensure that inputs from different devices are aligned in time and context, and allow for cohesive and integrated processing. The integration module 156 may manage the communication between the cloud 154 and external systems, such as databases and other cloud services, enabling the system to access additional data or functionality as needed.

Moreover, embodiments may include an interface module 158, a component that interprets user commands and interactions. The interface module 158 receives data from the integration module 156, including processed subvocal commands, gestures, and contextual data from the AR/VR device 162. It applies a algorithms and decision-making frameworks to determine the appropriate actions based on the received inputs. For instance, if a user issues a subvocal command to select an item in an AR shopping environment, the interface module 158 identifies this command, verifies its context, and decides on subsequent actions, such as highlighting the item or providing detailed information. The interface module 158 ensures that the user interface across all devices is consistent and responsive, adapting to different contexts and user behaviors to provide a seamless experience.

Further, embodiments may include a transaction module 160, which may handle secure transactions within the system, including scenarios involving purchases or sensitive data exchanges. The transaction module 160 interfaces with payment gateways, authentication services, and secure databases to process transactions initiated by the user, such as online shopping or service subscriptions. The transaction module 160 may ensure that all transactions are conducted securely, using encryption and secure communication protocols to protect user data. The transaction module 160 manages user authentication and authorization, verifying the user's identity and permissions before completing any transaction. In some embodiments, the transaction module 160 may track transaction history and provide receipts or confirmations to the user, maintaining transparency and accountability.

Further, embodiments may include an AR/VR device 162, which may be designed to provide users with an augmented or virtual reality experience. The AR/VR device 162 may serve as the interface for interacting with the digital environment, allowing users to engage with virtual elements and access enhanced information overlays in real time. The AR/VR device 162 may integrate the data and commands processed by the user device 102 and larynx member 134 to deliver a cohesive and interactive experience. In some embodiments, the AR/VR device 162 may include a high-resolution display system capable of rendering detailed and immersive graphics. For example, for AR applications, the AR/VR device 162 may use transparent or semi-transparent displays, such as heads-up displays, HUDs, or augmented reality glasses, to overlay digital content onto the real-world view, allowing users to see both the real environment and the virtual enhancements simultaneously. In virtual reality or VR mode, the AR/VR device 162 may employ fully immersive displays, such as VR headsets, which completely cover the user's field of view, immersing them in a fully virtual environment. In some embodiments, the display system may support high refresh rates and low latency, ensuring smooth and responsive visuals. In some embodiments, the AR/VR device 162 may be equipped with a range of sensors 168 that track the user's movements and interactions, including motion sensors, such as accelerometers and gyroscopes, which detect the orientation and movement of the AR/VR device 162. In some embodiments, the AR/VR device 162 may feature external tracking systems, such as cameras 166 and infrared sensors, which track the user's position in space and capture hand movements for gesture recognition. The sensor array may allow the AR/VR device 162 to accurately interpret the user's actions, whether they are moving through a virtual space, interacting with virtual objects, or navigating menus. The data collected by the sensors 168 may be processed in real time to update the virtual environment or augment the real-world view, providing a seamless interaction experience. In some embodiments, the AR/VR device 162 may include an advanced audio system that delivers spatial audio, enhancing the immersive experience by providing sound that corresponds to the user's virtual environment. In some embodiments, the audio system may use speakers or headphones to deliver high-quality audio, including directional cues that help users navigate and interact with the virtual world. In some embodiments, the AR/VR device 162 may also include microphones for capturing user voice inputs, which can be used for communication with other users or voice commands. In some embodiments, the AR/VR device 162 may leverage the data from the larynx member 134 and user device 102, allowing users to interact with the virtual environment through gestures, which are recognized by the AR/VR device's 162 sensors and cameras. In some embodiments, the gestures may include pointing, grabbing, or swiping, allowing users to manipulate virtual objects or navigate through interfaces. In some embodiments, the AR/VR device 162 may communicate with the user device 102 and larynx member 134 via wireless connections, such as Wi-Fi or Bluetooth, to receive real-time data and commands. In some embodiments, the AR/VR device 162 may connect to the cloud 154, which processes and manages user interactions. In some embodiments, the AR/VR device 162 may provide information overlays, such as navigation directions, product details in retail environments, or educational content in the AR mode. In VR mode, the AR/VR device 162 may offer immersive experiences for gaming, virtual meetings, simulations, and more. In some embodiments, the AR/VR device 162 may include adjustable straps, lightweight materials, and ergonomic shapes to ensure a comfortable fit for extended use. In some embodiments, the AR/VR device's 162 may be designed to minimize pressure points and include ventilation systems to prevent overheating, ensuring that users can wear it comfortably for long periods. In some embodiments, the AR/VR device 162 may be a mobile device, computer, etc. In some embodiments, the AR/VR device 162 may perform functions, such as phone calls, text messages, play videos, and internet searches both visually and auditorily through vocalizations or subvocalizations. In some embodiments, the AR/VR device 162 may pair or connect to a user's smartphone or mobile device through a plurality of communication channels, including but not limited to Wi-Fi, Bluetooth, USB cables, etc. In some embodiments, the AR/VR device 162 may receive commands inputted by the user on their smartphone or mobile device. In some embodiments, the AR/VR device 162 may provide social networking enhancements by utilizing augmented reality markers and real-time data integration, allowing users to engage in social interactions and networking in innovative ways by overlaying AR elements onto the physical world. In some embodiments, AR markers may be dynamically placed above people's heads in the user's field of view, visible through the AR headset, and provide quick access to information and interactions. For example, when looking at someone, an AR marker could display a summary of their social media profile, professional details, or personal interests. In some embodiments, the system may integrate with social media platforms to provide real-time access to user profiles, including LinkedIn, Facebook, Twitter, and other networks. In some embodiments, users may view AR profiles that appear as virtual cards or menus, providing a snapshot of the person's online presence. In some embodiments, users may use the larynx member 134 for subvocalization queries to interact with the AR system discreetly. For example, a user might subvocalize, “Does the person in front of me with the red long sleeve button down have a LinkedIn profile?” The larynx member 134 may capture the subvocalization and transmit it to the system for processing. In some embodiments, the system may search for the relevant profile using facial recognition and contextual clues like clothing. If the profile is found, it can be displayed in AR/VR device 162. In some embodiments, the profile details, such as name, profession, and key accomplishments, may be presented above the person's head or in a floating AR menu. In some embodiments, users may view detailed social media profiles in augmented reality, which may appear as interactive cards or menus. In some embodiments, the profiles may be browsed just like on a traditional screen, with options to scroll through posts, view photos, and read about the person's background. In some embodiments, the AI assistant may read out the profile details as if it were an audiobook providing an alternative to visual browsing, making it easier to consume information while keeping attention on the physical environment. In some embodiments, the system may provide a dating feature by enabling real-time, real-space interactions. For example, when a user finds someone attractive and subvocalizes this through the larynx member 134, the system detects this interest. If the other person also wears a larynx member 134 and reciprocates the interest, an automatic match is made, eliminating the traditional need for both parties to swipe right on each other, as seen on apps like Tinder, thereby reducing the risk of catfishing.

Further, embodiments may include a processor 164, which may manage and execute the tasks for delivering immersive augmented reality (AR) and virtual reality (VR) experiences. The processor 164 may be designed to handle the high-performance computing demands of real-time graphics rendering, sensor data processing, and user interaction management. The processor 164 may handle high-performance computing tasks efficiently. In some embodiments, the processor 164 may integrate multiple cores, including both high-power and low-power cores, to balance the workload and optimize power consumption. The high-power cores may be responsible for intensive tasks such as rendering high-definition graphics, complex simulations, and managing large datasets. The low-power cores may handle less demanding tasks, such as background processes and basic system operations, which helps conserve battery life and reduce heat generation. In some embodiments, a dedicated graphics processing unit, or GPU, may be included in the AR/VR device 162. The GPU may render detailed and realistic 3D graphics in real time. The GPU may accelerate the processing of complex graphical tasks, such as shading, lighting, and texture mapping, ensuring smooth and lifelike visuals. The GPU may work in tandem with the processor 164 to process and display the virtual environments, handling the bulk of the graphical computations, which is useful for maintaining high frame rates and minimizing latency. The processor 164 may process data from the array of sensors 168 integrated into the AR/VR device 162. The sensors 168 may include accelerometers, gyroscopes, magnetometers, and external tracking cameras, which collectively track the user's head movements, orientation, and position in real time. The processor 164 may rapidly process this data to update the user's viewpoint in the virtual environment, ensuring that the visual output accurately reflects the user's movements. In some embodiments, the real-time processing may maintain immersion and ensure that the virtual world responds instantly and accurately to the user's actions. In some embodiments, the processor 164 may include AI and machine learning capabilities, which may enhance user interactions, such as gesture recognition, voice command processing, and environmental mapping. In some embodiments, the AI may enable the AR/VR device 162 to learn from user behavior and adapt the virtual experience, accordingly, providing a more personalized and intuitive interface. For example, the processor 164 may recognize and interpret hand gestures captured by the AR/VR device's 162 cameras 166, translating them into commands for interacting with virtual objects. In some embodiments, the processor 164 may manage the communication interfaces, including Wi-Fi, Bluetooth, and cellular connections. The processor 164 may handle data exchange between the AR/VR device 162 and other components of the system, such as the user device 102, larynx member 134, and cloud 154 based services, including transmitting sensor data, receiving user inputs, and downloading updates or additional content from the cloud.

Further, embodiments may include a camera 166, which may comprise multiple cameras designed to capture real-world data, track user movements, and facilitate interaction with virtual environments. In some embodiments, the system may include a single camera 166 or multiple cameras 166. In some embodiments, the camera 166 may be an external tracking camera that is positioned on the exterior of the AR/VR device 162 and may be used for tracking the user's movements and the position of the AR/VR device 162 in space. The camera 166 may capture the environment around the user, detecting and tracking landmarks, objects, and surfaces to create a stable and realistic AR experience, allowing the AR/VR device 162 to overlay digital content accurately on top of the real world. In some embodiments, these camera 166 may establish a reference point in a VR environment for the user's movements, ensuring that the virtual environment responds correctly to their physical actions. In some embodiments, camera 166 may be depth-sensing cameras, such as a time-of-flight, or ToF, or structured light cameras, which measures the distance between the camera 166 and objects in the environment. In some embodiments, the camera 166 may provide 3D maps of the surroundings to understand spatial relationships and depth perception. This allows the AR/VR device 162 to accurately position virtual objects within the user's field of view and enable interactions such as object manipulation, navigation, and gesture recognition. In some embodiments, the camera 166 may be an eye-tracking cameras that is designed for eye tracking by monitoring the movement and position of the user's eyes, which provide data on where the user is looking. In some embodiments, eye tracking may enhance the immersive experience by enabling foveated rendering, where the highest graphical detail is focused on the area the user is directly looking at, while peripheral areas are rendered at lower resolutions. In some embodiments, the camera 166 may include hand-tracking cameras that capture detailed images of the user's hands and fingers, allowing the AR/VR device 162 to recognize gestures and hand movements. The camera 166 may be equipped with infrared sensors or other technologies to detect the shape and position of the hands even in low-light conditions. In some embodiments, hand tracking may enable intuitive interactions with the virtual environment, such as grabbing, pointing, and manipulating virtual objects. In some embodiments, the data captured by the cameras 166 may be processed by the processor 164 and GPU, which integrate this information with other sensor 168 data to create a cohesive and responsive experience. For example, external tracking and depth-sensing data may be combined to build a 3D model of the environment, while eye-tracking and hand-tracking data may be used to refine interactions and enhance immersion.

Further, embodiments may include a plurality of sensors 168, which enable the AR/VR device 162 to interact accurately with the user's environment and movements, providing an immersive and responsive experience. The sensors 168 may gather a wide range of data, from head and hand movements to environmental mapping. This is then processed to adjust the virtual or augmented reality environment in real time. In some embodiments, the sensors 168 may include accelerometers, which may measure the rate of change of velocity, or acceleration, along one or more axes. In some embodiments, the accelerometers may be used to detect linear movements, such as tilting, shaking, or moving the AR/VR device 162 in a particular direction. In some embodiments, the data may assist in determining the position and movement of the AR/VR device 162 relative to its starting point, such as for tasks like navigation and interaction within the virtual environment. In some embodiments, the sensors 168 may include gyroscopes, which measure the rate of rotational movement around the AR/VR device's 162 axes. The gyroscopes may detect changes in orientation, such as looking left or right, up or down, or tilting the head. They may provide six degrees of freedom tracking, which covers both rotational and translational movements. This allows the AR/VR device 162 to track head orientation and movement, providing a seamless experience as the user's viewpoint changes. In some embodiments, the sensors 168 may include magnetometers, which measure magnetic fields and may be used as digital compasses in AR/VR devices 162. The magnetometers may determine the AR/VR device's 162 orientation relative to the Earth's magnetic field to establish a reference point for the AR/VR device's 162 orientation. In some embodiments, the magnetometers may be combined with accelerometers and gyroscopes in an inertial measurement unit, or IMU, to provide comprehensive orientation data, which may correct drift and ensure accurate tracking, especially over extended periods. In some embodiments, the sensors 168 may include proximity sensors which may detect the presence of objects or users near the AR/VR device 162, such as detecting when the device is being worn or removed. For example, the proximity sensors may detect when the headset is placed on the user's head, automatically turning on the AR/VR device 162 or adjusting the display settings. In some embodiments, the sensors 168 may include depth sensors which may measure the distance between the sensor 168 and objects in the environment. In some embodiments, the depth sensors may be used to map the three-dimensional space around the user, providing data on the depth and spatial arrangement of objects. In some embodiments, the sensors 168 may include microphones that capture audio inputs, enabling voice commands and communication within the virtual environment. In some embodiments, the sensors 168 may include environmental sensors that monitor environmental conditions, such as ambient light sensors that adjust the display brightness based on the surrounding lighting or temperature sensors that help manage cooling systems.

Further, embodiments may include a display 170, which may provide high-quality visuals that are immersive, clear, and responsive, contributing to overall realism and user engagement. In some embodiments, the display 170 may be an OLED display, LCD panel, or micro-LED display. In some embodiments, the resolution of the display 170 may include 1080 p, 1440 p, and even 4K per eye, etc., and may include a field of view ranging from 90 to 120 degrees or more. In some embodiments, the display 170 may include higher refresh rates, such as 90 Hz or 120 Hz. In some embodiments, the display 170 may utilize a lens system to project the image into the user's eyes. In some embodiments, the lenses may create a sense of depth and 3D perception by providing separate images to each eye, mimicking the way humans naturally see the world.

Further, embodiments may include a memory 172, which may comprise volatile memory, such as RAM and VRAM, and non-volatile storage. In some embodiments, the RAM may temporarily store data needed for running applications and processing tasks. At the same time, the VRAM may be used by the GPU to manage graphical data, ensuring the smooth rendering of high-resolution images and scenes. In some embodiments, non-volatile memory may include internal storage, such as flash memory, for permanently storing the operating system, applications, and user data. In some embodiments, the memory 172 may incorporate CPU and GPU caches for quick data access, improving performance. In some embodiments, cloud storage integration may allow for extended storage and data backup.

Further, embodiments may include an AR module 174, which connects to the cloud 154 to sync configurations and retrieve necessary data. The AR module 174 initializes and manages the AR/VR environment by loading assets, activating the rendering engine, integrating sensor data for tracking, and setting up user interfaces. The AR module 174 continuously sends real-time AR/VR data to the integration module 156 in the cloud 154 and receives interaction data, including commands and updates. The AR module 174 updates the environment dynamically, adjusting visuals, interactions, and system performance based on the received data.

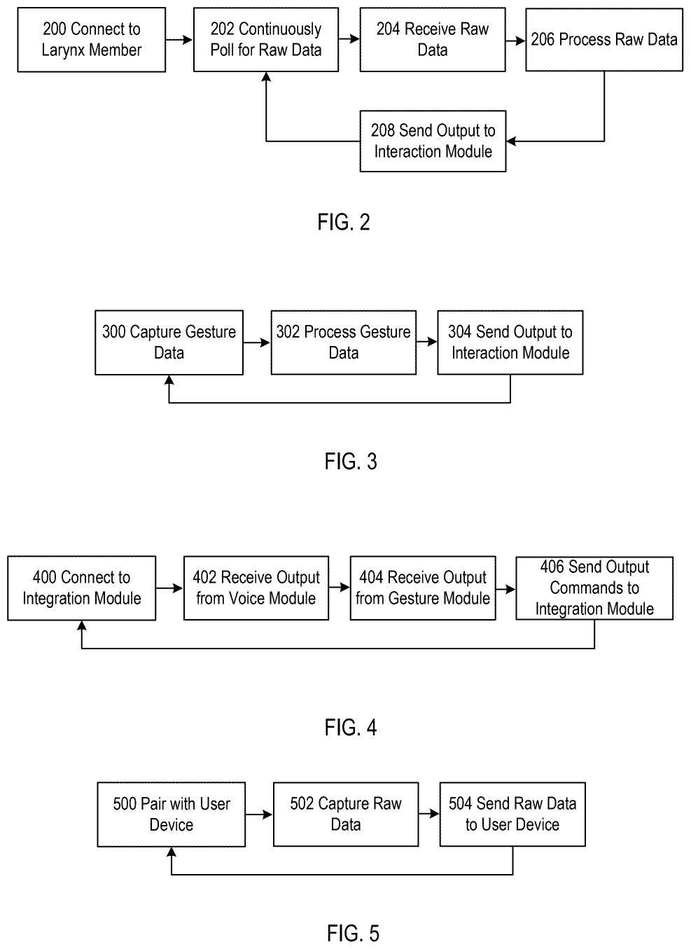

FIG. 2 illustrates the voice module 126. The process begins with the voice module 126 connecting, at step 200, to the larynx member 134. The voice module 126 may initiate a handshake protocol with the larynx member 134 to set up a communication link, which may involve agreeing on the communication protocol to be used, such as Bluetooth or Wi-Fi, which determines the speed and range of data transmission. The devices may perform a secure pairing process, which includes authentication steps to verify the identity of the devices and prevent unauthorized access. In some embodiments, the pairing process may include the exchange of encryption keys and authentication tokens to ensure that the communication channel is secure and that the data exchanged remains confidential. In some embodiments, the devices may confirm the pairing to ensure that the voice module 126 may communicate with the larynx member 134. The voice module 126 continuously polls, at step 202, for the raw data from the larynx member 134. In some embodiments, the voice module 126 may periodically send requests to the larynx member 134 to check for new subvocalization data captured by the larynx member. The frequency of polling is optimized to balance real-time data retrieval with efficient power usage. The module may ensure it receives data updates quickly enough to process them in real time without overwhelming the communication channel or the processing capabilities of the user device. In some embodiments, the voice module 126 may manage any potential latency issues to ensure that data is synchronized accurately between the devices, which may involve time-stamping data packets or using synchronization algorithms to align the data stream. The voice module 126 receives, at step 204, the raw data from the larynx member 134. In some embodiments, the voice module 126 may receive data packets containing the raw subvocalization signals, including the digital representations of the analog signals captured by the larynx member's 134 piezoelectric sensing array 136. In some embodiments, the voice module 126 may perform integrity checks, such as error checking and verification, to ensure that the data has not been corrupted during transmission. In some embodiments, the received data may be temporarily buffered to prepare it for processing, which may include organizing the data in the correct order and ensuring that any partial data packets are completed. The voice module 126 processes, at step 206, the raw subvocalization data. For example, the voice module 126 may apply signal processing techniques to clean and refine the data, including filtering out noise, normalizing signal levels, and enhancing features of the signal that are relevant for further analysis. The processed signals may be analyzed to extract features that are indicative of specific subvocalizations, including identifying patterns in frequency, amplitude, or timing that correspond to different words, phrases, or commands. The voice module 126 may use pre-trained machine learning models to interpret the extracted features. For example, the machine learning and training module 124 may train the models on a dataset of known subvocalizations. It may classify the incoming data into recognized categories, translating the raw subvocalization signals into understandable text or commands. The voice module 126 sends, at step 208, the output to the interaction module 130, and the process returns to continuously polling for the raw data. In some embodiments, the output data, such as text, command instructions, etc., may be formatted and encoded for transmission to the interaction module. For example, the command may be to add an item to a shopping cart in an AR or VR environment that the user is viewing through the AR/VR device 162. The voice module 126 may return to polling for new data from the larynx member 134 to process and respond to new subvocalizations in real time.

FIG. 3 illustrates the gesture module 128. The process begins with the gesture module 128 capturing, at step 300, the gesture data. The gesture module 128 may activate various sensors that detect motion and gestures, such as accelerometers, gyroscopes, magnetometers, etc. The sensors may collect raw data as the user performs gestures. For example, accelerometers measure the speed and direction of movement, and gyroscopes track rotational changes and may include information on the gesture's direction, speed, orientation, and any other relevant metrics. The gesture module 128 may continuously monitor the sensors to detect when a gesture begins, track its progress, and note when it ends. In some embodiments, real-time monitoring may capture the full scope of the gesture to ensure that the data accurately represents the user's actions. The gesture module 128 may ensure that data from all sensors is synchronized to provide a cohesive and accurate representation of the gesture. The gesture module 128 processes, at step 302, the gesture data. The gesture module 128 may preprocess the raw sensor data to filter out noise and irrelevant information, which may include cleaning the data to remove artifacts that environmental factors or sensor limitations may have introduced. The gesture module 128 may analyze the cleaned data to extract specific features that are indicative of particular gestures, including identifying patterns in the movement data, such as specific trajectories, velocities, or rotations that correspond to predefined gestures. The extracted features may then be compared against a database of pre-existing training data. In some embodiments, the database may contain a wide range of gesture patterns and corresponding interpretations that have been collected and refined over time. The gestural training data processing 108 system may utilize machine learning algorithms to match the captured data with known gesture patterns. In some embodiments, the gestural training data processing 108 system may improve the accuracy of gesture recognition by continuously learning from new data and refining its pattern-matching algorithms. Based on the training data and real-time analysis, the gesture module 128 may classify the gestures into recognized categories. In some embodiments, machine learning models, such as neural networks or support vector machines, may be used to perform the classification and account for subtle variations in gestures to ensure accurate recognition. The gesture module 128 may also consider the context in which the gesture was made, which may involve analyzing factors such as the current application being used, the user's previous interactions, and the environmental conditions. In some embodiments, the contextual analysis may assist in distinguishing between a swipe intended to change a page versus a swipe to close an application. The gesture module 128 sends, at step 304, the output of the processed gesture data to the interaction module 130. The recognized gestures may be formatted into a structured output, such as commands or specific instructions. They may include the type of gesture, its parameters, such as direction or intensity, and any contextual information that may influence its interpretation. The formatted output is transmitted to the interaction module 130 in real time through the communication channels. In some embodiments, the interaction module 130 may send an acknowledgment back to the gesture module to confirm data reception. In some embodiments, the gesture module 128 may then continue to monitor and capture new gesture data and repeat the process to provide continuous and responsive user interaction.

FIG. 4 illustrates the interaction module 130. The process begins with the interaction module 130 connecting, at step 400, to the integration module 156. In some embodiments, the interaction module 130 may initiate a handshake protocol with the integration module 156 to set up a communication link, which may involve agreeing on the communication protocols, such as secure APIs or data exchange formats, to ensure that the data transmitted between the modules is compatible and secure. In some embodiments, the interaction module 130 may verify the identity of the integration module 156 by exchanging cryptographic keys or tokens. In some embodiments, the interaction module 130 may check for proper authorization to ensure that the interaction module 130 has the necessary permissions to communicate with the integration module 156 and access certain functionalities or data. In some embodiments, the interaction module 130 may confirm the connection, which may be kept open or re-established as needed to facilitate ongoing communication throughout the user device's 102 operation. The interaction module 130 receives, at step 402, the output from the voice module 126. The interaction module 130 may continuously receive data packets from the voice module 126, which may contain the interpreted results of subvocal commands captured by the larynx member 134, such as recognized commands or textual representations of the user's subvocalizations. In some embodiments, the interaction module 130 may validate the received data to ensure it has been transmitted correctly and without errors. In some embodiments, the interaction module 130 may parse the data and organize it into a structured format for further processing, which may include interpreting the data fields and extracting information, such as command type, parameters, and context. In some embodiments, the validated and parsed data may be temporarily stored or queued within the interaction module 130 to ensure that the interaction module 130 can manage multiple data inputs simultaneously. The interaction module 130 receives, at step 404, the output from the gesture module 128. The interaction module 130 receives data packets from the gesture module 128, which may contain the interpreted results of the user's physical gestures, such as swipes, taps, or hand movements. In some embodiments, the interaction module 130 may validate the gesture data for integrity and accuracy to ensure that it is free from errors. In some embodiments, the data is then parsed to identify the specific gestures, their parameters, such as direction, speed, or duration, and any associated context. In some embodiments, the interaction module 130 may temporarily store the gesture data alongside the subvocalization data. In some embodiments, parallel processing may be used to ensure that the interaction module 130 can handle and coordinate multiple inputs. The interaction module 130 sends, at step 406, the output commands to the integration module 156. The interaction module 130 may synthesize the received data into actionable commands, which may include combining voice and gesture inputs to form a comprehensive command or selecting the most appropriate action based on the context and user intent. The formatted commands are securely transmitted to the integration module 156. In some embodiments, the communication may be encrypted to protect the data during transfer. In some embodiments, the interaction module 130 may receive an acknowledgment from the integration module 156 to confirm that the commands have been successfully received and processed.

FIG. 5 illustrates the capture module 152. The process begins with the capture module 152 being paired, at step 500, with the user device 102. In some embodiments, the larynx member 134 may be activated and enter a pairing mode, making itself discoverable to nearby devices. In some embodiments, the pairing mode may be initiated manually by the user or automatically when the device is powered on for the first time. For example, the user device 102 may scan for available devices in the vicinity and identify the larynx member 134. The user device 102 may engage in a mutual authentication process involving exchanging secure keys or codes to ensure that both devices recognize each other and that the connection is legitimate. The devices establish a data communication channel, which may be based on Bluetooth, Wi-Fi, or another wireless protocol, depending on the device's capabilities. In some embodiments, the connection parameters, such as frequency and bandwidth, may be negotiated to optimize data transfer rates and reliability. The devices confirm the successful pairing and may provide visual or auditory feedback to the user. In some embodiments, the user device 102 may then configure specific settings for the larynx member 134, such as data encryption protocols, sampling rates for data capture, and other preferences that optimize the performance and security of the data exchange. The capture module 152 captures, at step 502, the raw data. For example, the piezoelectric sensing array 136 in the larynx member 134 may be activated and may be designed to detect subtle muscle movements associated with subvocalizations. In some embodiments, the piezoelectric sensing array 136 may be highly sensitive and may capture a wide range of frequencies and amplitudes, providing detailed information about muscle activity. As the user subvocalizes or engages in silent speech, the piezoelectric sensing array 136 may capture the mechanical vibrations and convert them into analog electrical signals, which represent the raw data that includes detailed information about the timing, frequency, and amplitude of the muscle movements. In some embodiments, the raw analog signals may then be converted into digital data by an ADC unit within the larynx member 134. In some embodiments, the capture module 152 may perform preprocessing, such as noise reduction, filtering out irrelevant signals, and normalizing the data to ensure consistency and accuracy in the readings. The capture module 152 sends, at step 504, the raw data to the user device, and the process returns to capturing the raw data. In some embodiments, the captured data may be packaged into packets or frames suitable for transmission. The data may be encoded to ensure integrity and prevent loss or corruption during transmission, using techniques such as error correction codes and compression algorithms to optimize data transfer. In some embodiments, the data packets may be transmitted over the established wireless connection to the user device 102. The communication channel may be secured using encryption protocols to protect the data from interception or unauthorized access. In some embodiments, the user device 102 may receive the transmitted data and may send an acknowledgment back to the capture module 152 to confirm the successful receipt of the data. In some embodiments, the capture module 152 may continue to capture and send data in a continuous loop, providing real-time updates to the user device 102.

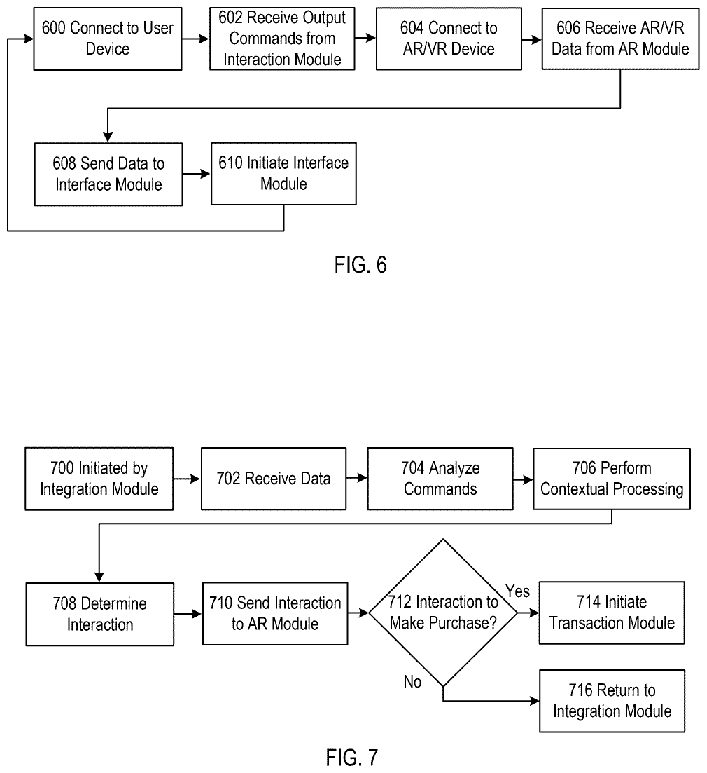

FIG. 6 illustrates the integration module 156. The process begins with the integration module 156 connecting, at step 600, to the user device 102. The integration module 156 may initiate a handshake protocol with the user device 102, which may involve selecting the appropriate communication protocols, such as HTTPS, MQTT, or WebSocket, to ensure efficient and secure data transmission. In some embodiments, the integration module 156 and user device 102 authenticate each other. In some embodiments, the integration module 156 and user device 102 may confirm the connection. The integration module 156 receives, at step 602, the output commands from the interaction module 130. The integration module 156 may continuously receive data packets containing output commands from the interaction module 130. The integration module 156 may validate the received data to ensure it has been transmitted without errors or corruption. In some embodiments, the data may be parsed to extract the specific commands, parameters, and any additional contextual information. In some embodiments, the validated data may be temporarily stored in the integration module's 156 buffer or queue. The integration module 156 connects, at step 604, to the AR/VR device 162. In some embodiments, the integration module 156 may discover the AR/VR device 162 on the network and initiate a handshake to establish communication, which may involve selecting appropriate protocols and negotiating connection parameters such as bandwidth and latency requirements. In some embodiments, the integration module 156 and AR/VR device 162 may authenticate each other to ensure secure data exchange. In some embodiments, the integration module 156 and AR/VR device 162 may confirm the connection. The integration module 156 receives, at step 606, the AR/VR data from the AR module 174. The integration module 156 receives data packets from the AR/VR device 162, which may include information such as user position, orientation, environmental mapping, and other AR/VR context data. The integration module 156 may validate the AR/VR data to ensure its integrity and accuracy. It also parses the data to extract relevant information, such as user interactions, environmental changes, or AR overlays, which are helpful for providing a seamless AR/VR experience. In some embodiments, the received AR/VR data may be integrated with the output commands from the user device 102 to create a cohesive data set that reflects both user commands and the current state of the AR/VR environment. The integration module 156 sends, at step 608, the output command data and AR/VR data to the interface module 158. The integration module 156 may synthesize the combined data into a structured format suitable for the interface module 158, which may include organizing the data based on priority, context, and intended actions. The data may be transmitted to the interface module 158 using encrypted communication channels to ensure data integrity and confidentiality. In some embodiments, the interface module 158 may acknowledge receipt of the data to confirm that it has been successfully received. The integration module 156 initiates, at step 610, the interface module 158, and the process returns to connecting to the user device 102. The interface module 158 may interpret user commands and interactions. The interface module 158 may receive data from the integration module 156, including processed subvocal commands, gestures, and contextual data from the AR/VR device 162. The interface module 158 may apply advanced algorithms and decision-making frameworks to determine the appropriate actions based on the received inputs. For example, suppose a user issues a subvocal command to select an item in an AR shopping environment. In that case, the interface module 158 may identify this command, verify its context, and decide on subsequent actions, such as highlighting the item or providing detailed information. The interface module 158 may ensure that the user interface across all devices is consistent and responsive, adapting to different contexts and user behaviors to provide a seamless experience.

FIG. 7 illustrates the interface module 158. The process begins with the interface module 158 being initiated at step 700 by the integration module 156. The interface module 158 may activate its core processes and configure its settings based on the requirements specified by the integration module 156, including setting up necessary computational resources, allocating memory, and initializing communication protocols. The interface module 158 receives, at step 702, the data from the integration module 156. The interface module 158 may continuously receive data packets from the integration module 156, such as processed user commands, contextual information, and any AR/VR data for further processing. The interface module 158 may validate the data to ensure it is complete and free from corruption, including checking the integrity of the data packets, verifying signatures if necessary, and confirming that the data aligns with the expected formats and structures. In some embodiments, the received data may be temporarily stored in a secure buffer within the interface module 158. The interface module 158 analyzes, at step 704, the received commands. The interface module 158 may parse the commands, breaking them down into actionable components, which may involve identifying the type of command, such as navigation, interaction, or transaction, and extracting relevant parameters. The parsed commands may be categorized based on their function and priority. For example, commands related to user interactions in the AR/VR environment may be prioritized differently from those involving background data processing. The interface module 158 may assess the contextual relevance of the commands, considering factors such as the current state of the AR/VR environment, user preferences, and any ongoing interactions. The interface module 158 performs, at step 706, contextual processing. The interface module 158 may integrate additional contextual data, such as user history, environmental conditions, and real-time system status, to provide a more comprehensive understanding of the situation. The interface module 158 may apply decision-making algorithms, such as artificial intelligence or rule-based systems, to determine the most appropriate response based on the context, including selecting the best route in navigation, identifying the most relevant content for display, or adjusting the user interface dynamically. The interface module 158 determines, at step 708, the interaction. The interface module 158 determines the interaction, specifying the actions to be taken, including defining the steps, the order of execution, and any dependencies or conditions that should be met. The determined interaction may be optimized for efficiency and effectiveness, which may involve streamlining the process, reducing resource consumption, or enhancing the user experience by minimizing latency and improving responsiveness. The interaction plan may be validated to ensure it is feasible and safe. For example, the interface module 158 may verify that the planned actions do not conflict with other processes or pose risks to system stability or user privacy. For example, if the user has gestured towards or subvocalized the name of a product, the interface module 158 may interpret this action as a selection command. The user might look at a virtual display of shoes and say, “Add these to my cart,” while pointing at a specific pair. The system may identify the specific product, including details like size, color, and style. The user may request more information about a product by saying something like “Tell me more about this item.” The interface module 158 may process the request and prepare to display detailed product information, such as specifications, reviews, and price comparisons. Suppose the user wants to explore different product categories, such as moving from electronics to clothing. In that case, the system may recognize gestures like a swipe or verbal commands like “Show me women's jackets.” The interface module 158 may determine this as a navigation command and prepare the necessary interaction to change the displayed content. The interface module 158 sends, at step 710, the interaction to the AR module 174. The interaction data may be packaged into a format suitable for the AR module 174 to ensure that all information is included and structured. In some embodiments, the data may be securely transmitted to the AR module 174 using encrypted communication channels to protect the data from interception or tampering during transfer. In some embodiments, the AR module 174 may confirm the receipt of the data to ensure that the interaction has been successfully communicated and is ready for execution. For example, if the user requests more information, the AR module 174 may overlay detailed product specs, user reviews, and other relevant data onto the product's image in the AR environment, including 3D views, videos, or even an AR demonstration of the product in use. For a product selection, the system may visually confirm the addition of the item to the shopping cart, such as displaying a notification or an icon update in the user's field of view. The AR module 174 may show the updated cart total and suggest related items. When navigating between categories, the AR module 174 may visually transition the environment, changing the display to show the new category's products, which may involve a virtual walkthrough of different sections or shelves in a virtual store. In some embodiments, the interaction module 158 may send commands, interactions, or prompts to an autonomous vehicle. In some embodiments, the system may utilize the subvocalizations of the user to input a destination to an autonomous vehicle. For example, the user may subvocalize an address or a destination, and the system may process the request and send directions to the autonomous vehicle to bring the user to the specified location. In some embodiments, the users may use the AI assistant for recommendations, such as “top-rated bagel places within 5 miles,” and the AI assistant provides the options to the user, allowing the user or the AI assistant to randomly select the option and send the directions to the autonomous vehicle. In some embodiments, users may use the system to inquire about their surroundings through subvocalization. For example, sitting in the back right passenger seat, a user might subvocalize, “What's that building on my right with the bricks and the red roof?” The AI assistant may process this query by accessing the vehicle's navigation system, onboard cameras, and the cameras 166 and location data, or even data from a paired mobile device. In some embodiments, the system may integrate these data sources, allowing the AI assistant to provide an informed analysis of the building, offering detailed information and enhancing the user's awareness and interaction with their environment. The interface module 158 determines, at step 712, if the interaction was to execute a purchase. The interface module 158 may classify the interaction based on its content, identifying if it involves a purchase transaction, which may include checking for commands related to cart operations, payment processes, or order confirmations. If the interaction involves a purchase, the interface module 158 may verify the user's intent, ensuring that the action is intentional and authorized, such as requesting additional authentication steps or user confirmations. For example, if the user says, “Proceed to checkout” or “Buy now,” the system may recognize this as an intent to make a purchase. In some embodiments, the system may allow a user to pick up an item or look at an item in a shopping environment and command the system to purchase the item through subvocalizations to buy and checkout the item. In some embodiments, the system may confirm a purchase command with a user before proceeding with the checkout, either through the AR/VR device 162, user device 102, the AI assistant, etc. The interface module 158 may verify if all necessary details, such as shipping address and payment method, are available or if further input is needed. The user might ask, “Are there any discounts?” or “Apply my coupon.” The interface module 158 may check for applicable discounts, loyalty points, or promotional codes that can be applied to the purchase. The interface module 158 may seek a final confirmation from the user to complete the purchase, including a security check, such as a voice confirmation or a gesture, to ensure that the user authorizes the transaction. If the interaction was to execute a purchase the interaction module 158 initiates, at step 714, the transaction module 160. The transaction module 160 may handle secure transactions within the system, including scenarios involving purchases or sensitive data exchanges. The transaction module 160 interfaces with payment gateways, authentication services, and secure databases to process transactions initiated by the user, such as online shopping or service subscriptions. The transaction module 160 may ensure that all transactions are conducted securely, using encryption and secure communication protocols to protect user data. The transaction module 160 manages user authentication and authorization, verifying the user's identity and permissions before completing any transaction. In some embodiments, the transaction module 160 may track transaction history and provide receipts or confirmations to the user, maintaining transparency and accountability. If the interaction was not to execute a purchase or after the transaction module 160 is initiated, the interface module 158 returns, at step 716, to the integration module 156.

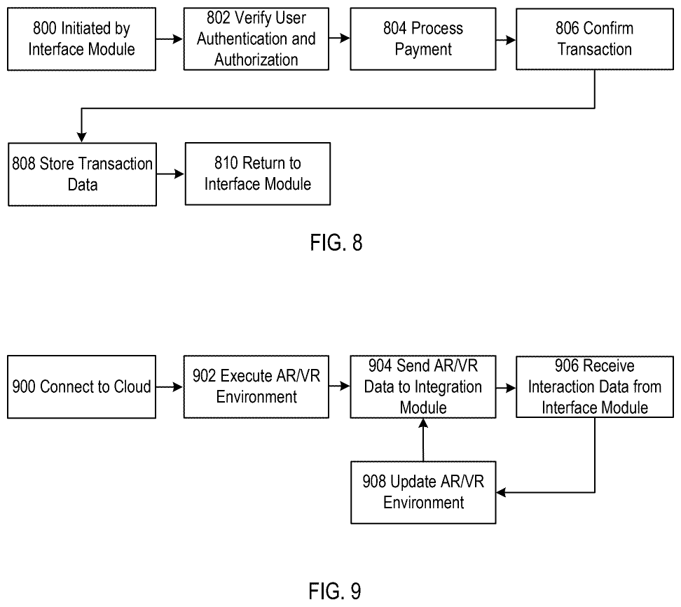

FIG. 8 illustrates the transaction module 160. The process begins with the transaction module 160 being initiated at step 800 by the interface module 158. In some embodiments, the transaction module 160 may receive a request from the interface module to initiate a purchase, which may include details such as the items to be purchased, their quantities, total cost, and any discounts or promotional codes applied. In some embodiments, the transaction module 160 may validate the received data to ensure that all necessary details are present and correct. The transaction module 160 verifies, at step 802, the user authentication and authorization. The transaction module 160 may perform user authentication to ensure that the person initiating the transaction is authorized to do so, which may involve verifying credentials such as passwords, biometric data, such as facial recognition or fingerprints, or security questions. The transaction module 160 may verify that the user has the necessary permissions and funds to complete the transaction, including checking for sufficient balance or credit in the payment method and ensuring that any necessary approvals or parental controls are satisfied. The transaction module 160 processes, at step 804, the payment. The user may be prompted to confirm or select their preferred payment method, such as a credit card, digital wallet, or bank transfer. In some embodiments, if multiple payment options are available, the system may recommend the most suitable option based on user preferences or past transactions. The transaction module 160 processes the payment once the payment method is confirmed, which may involve securely transmitting payment details to the relevant financial institution or payment gateway. In some embodiments, encryption protocols, such as TLS/SSL, may be used to protect sensitive information during transmission. In some embodiments, the system may await confirmation from the payment processor that the payment has been successfully authorized and processed. In some embodiments, if the payment fails for any reason, such as insufficient funds or card declined, the transaction module 160 may handle the error and prompt the user to try an alternative payment method or rectify the issue. In some embodiments, the transaction module 160 may apply any eligible discounts or promotional codes to the transaction. In some embodiments, the transaction module 160 may calculate the appropriate taxes based on the user's location and the nature of the goods or services being purchased, including local, state, or federal taxes as applicable. In some embodiments, the system may confirm the final transaction amount, including the cost of items, taxes, shipping fees, and any discounts. In some embodiments, the user may be provided with a detailed breakdown of the total cost. The transaction module 160 confirms, at step 806, the transaction. The transaction module 160 may generate an order confirmation, including an order number, itemized receipt, delivery details, and estimated delivery time. The transaction module 160 may send the order confirmation to the user via the chosen communication channel, such as email, SMS, or an in-app notification, which serves as a record of the purchase and provides the user with all necessary details for tracking their order. The transaction module 160 may notify the relevant vendor or service provider of the order, initiating the fulfillment process, including providing all necessary details for shipping, inventory management, and delivery. The transaction module 160 stores, at step 808, the transaction data. In some embodiments, the transaction details may be logged in the system's database for record-keeping and future reference. In some embodiments, the system may engage the user post-transaction with additional actions, such as offering related products, providing feedback options, or enrolling the user in loyalty programs. The transaction module 160 returns, at step 810, to the interface module 158.

FIG. 9 illustrates the AR module 174. The process begins with the AR module 174 connecting, at step 900, to the Cloud. The AR module 174 establishes a connection to the cloud 154 infrastructure by using secure communication protocols such as HTTPS or WebSocket to ensure data integrity and confidentiality. In some embodiments, the AR module 174 may perform authentication to verify its identity to the cloud 154 services to ensure that only authorized devices can access the system, which may involve the use of digital certificates, tokens, or other authentication mechanisms. In some embodiments, the AR module 174 may sync with the cloud 154 to retrieve any necessary configurations, updates, or synchronization data, including settings for the AR/VR environment, user preferences, and any real-time data required for the operation. The AR module 174 executes, at step 902, the AR/VR environment. The AR module 174 may initialize the AR/VR environment, loading the necessary assets, scenes, and interactive elements, including 3D models, textures, animations, and any other visual or audio assets required to create the immersive environment. In some embodiments, the AR module 174 may activate a rendering engine, which is responsible for generating the visual output seen by the user, which may involve setting up the graphics pipeline, including shaders, lighting, and rendering techniques like ray tracing or rasterization. The AR module 174 may integrate data from various sensors 168, including cameras 166, accelerometers, gyroscopes, and possibly external tracking systems. The sensor 168 data may be used to track the user's movements, position, and orientation, ensuring that the AR/VR environment responds accurately to real-world actions. The AR module 174 may set up the user interface and interaction elements, such as menus, buttons, and virtual objects. In some embodiments, the elements allow the user to interact with the environment, make selections, and receive feedback. The AR module 174 sends, at step 904, the AR/VR data to the integration module 156. The AR module 174 may collect real-time data from the environment, including user interactions, environmental changes, and system status updates that provide a comprehensive view of the current state of the AR/VR experience. The collected data may be packaged into a structured format suitable for transmission, including organizing data into packets, compressing it if necessary, and ensuring that it adheres to the expected format for the integration module. The data may be transmitted to the integration module 156 in the cloud 154. In some embodiments, encryption protocols may be used to protect the data during transit to ensure that sensitive information remains confidential and intact. The AR module 174 receives, at step 906, the interaction data from the interface module 158. The AR module 174 may receive interaction data from the interface module 158, including commands, updates, and adjustments based on user actions and system responses, such as changing scenes, interacting with objects, or executing specific functions. The received data may be validated to ensure it is complete and error-free. In some embodiments, the AR module 174 may parse the data to extract actionable commands and relevant information to ensure that the instructions are clear and executable. The parsed commands are queued for execution. The AR module 174 may prioritize these commands based on urgency, relevance, and the current state of the AR/VR environment. In some embodiments, the AI assistant may be designed to communicate with users through various audio output methods, ensuring clear and effective interaction in different scenarios. The communication methods may include transcranial induction, headphones, and speakers. Transcranial induction may be a technology that allows the AI assistant to transmit audio signals directly to the user's inner ear via bone conduction, which may be performed wirelessly or through wired connections. In some embodiments, wireless transcranial induction may use a small transducer placed against the user's skull. The transducer converts audio signals into vibrations that travel through the bones of the skull to the inner ear, where they are interpreted as sound. In some embodiments, transcranial induction may allow the user to hear audio without blocking the ear canal, enabling awareness of environmental sounds. In some embodiments, wireless transcranial induction may be useful for continuous, hands-free communication with the AI assistant, such as for navigation, where the user needs to be aware of their surroundings while receiving directions. In some embodiments, wired transcranial induction may use a transducer placed against the skull, connected to the AI assistant via a cable. In some embodiments, wired connections may provide more consistent signal quality and may not require battery power for the transducer, making them reliable for long-duration use. In some embodiments, wired connections may be used for stationary tasks or activities where the user remains in one location, such as working at a desk or during a workout session where movement is minimal. In some embodiments, headphones may be connected to the AI assistant either wirelessly or through wired connections. In some embodiments, wireless headphones may connect to the AI assistant using Bluetooth or other wireless technologies. They may be used for making phone calls, listening to media, and interacting with the AI assistant while walking, exercising, or commuting. In some embodiments, wired headphones may connect to the AI assistant using a cable, such as a standard audio jack or USB connection. They may be used for stationary applications, such as working at a computer, studying, or watching videos, where the presence of a cable does not hinder movement. In some embodiments, the AI assistant may also communicate through built-in or external speakers, providing audio output that does not require the user to wear any additional devices. In some embodiments, the AI assistant may use integrated speakers within the device to output sound directly to the user. The AR module 174 updates, at step 908, the AR/VR environment, and the process returns to sending the AR/VR data to the integration module 156. The AR module 174 executes the received commands, which may involve updating the visual elements, changing the scene, modifying the user interface, or interacting with virtual objects in real time, providing immediate feedback to the user. The AR module 174 may adjust the AR/VR environment dynamically based on user interactions and real-time data, including updating the positions of virtual objects, changing lighting conditions, or altering soundscapes to enhance immersion. The AR module 174 may continuously monitor the performance of the AR/VR environment, optimizing resources such as CPU, GPU, and memory 172 usage. The AR module 174 sends updated AR/VR data back to the integration module 156 to create a feedback loop that allows the system to adjust and refine the experience continually.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. A system for enhancing an immersive online digital experience, the system comprising:
a piezoelectric sensing array that detects analog waveforms that correspond to larynx muscle movements during subvocalization by a user;
a processor that executes stored instructions from a memory to convert the analog waveforms into a three-dimensional data representation of larynx muscle movement;
a subvocalization machine learning module that compares the three-dimensional data representation with a pre-established training set of larynx muscle movements thereby deriving a first set of user commands from the three-dimensional data representation;
a capacitive touch recognition surface that detects one or more gestures of the user on an X-Y grid plane of the surface;
a gestural machine learning module that interprets the one more gestures as a second set of user commands; and
an immersive digital device that provides real-time responses to the user, including auditory and visual feedback that facilitates an online transaction responsive to the first and second sets of user commands.

2. The system of claim 1, further comprising an ultrasound gel that vibrationally transmits larynx muscle movements to the piezoelectric sensing array.

3. The system of claim 1, further comprising an accelerometer that generates acceleration data responsive to measurement of acceleration, wherein the acceleration data and three-dimensional data representation of larynx muscle movement distinguish subvocalizations from other bodily movements.

4. The system of claim 1, further comprising a radar that detects gestures in free space, and wherein the radar detection and capacitive touch screen allow for a determination of gestures in a three-dimensional space.

5. The system of claim 1, wherein the immersive digital device provides for augmented reality (AR) and is coupled to a cloud-based network to facilitate the online transaction.

6. The system of claim 1, wherein the immersive digital device provides for virtual reality (VR) and is coupled to a cloud-based network to facilitate the online transaction.

7. The system of claim 1, wherein the online transaction is a purchase of a product or service.

8. (canceled)

9. The system of claim 1, wherein the subvocalization machine learning module and the gestural machine learning module each use one or more of a large language model (LLM), convolutional neural network (CNN), recurrent neural network (RNN), support vector machine (SVM), random forest, hidden Markov model (HMM), autoencoder, principle component analyzer, Bayesian network, k-nearest neighbor algorithm, reinforcement learning algorithm, Gaussian mixture model, or a transfer learning model.

10. (canceled)

11. A method for enhancing an immersive online digital experience, the method comprising:
detecting analog waveforms that correspond to larynx muscle movements during user subvocalization using a piezoelectric sensing array;
converting the analog waveforms into a three-dimensional data representation of larynx muscle movement responsive to a process executing instructions stored in a memory;
comparing the three-dimensional data representation with a pre-established training set of larynx muscle movements at a subvocalization machine learning module, thereby deriving a first set of user commands from the three-dimensional data representation;
detecting one or more gestures of the user on an X-Y grid plane of a capacitive touch recognition surface;
interpreting the one more gestures at a gestural machine learning module as a second set of user commands; and
providing real-time responses to the user at an immersive digital device, wherein the real-time responses include auditory and visual feedback that facilitate an online transaction responsive to the first and second sets of user commands.

12. The method of claim 11, further comprising facilitating a vibrational transmission of larynx muscle movements to the piezoelectric sensing array using an ultrasound gel.

13. The method of claim 11, further comprising:
generating acceleration data responsive to measurement of acceleration at an accelerometer; and
distinguishing subvocalizations from other movements based on the acceleration data and three-dimensional data representation of larynx muscle movements.

14. The method of claim 11, further comprising determining gestures in a three-dimensional space using a radar and the capacitive touch screen, wherein the radar detects gestures in free space.

15. The method of claim 11, wherein facilitating the online transaction takes place over a cloud-based network using an augmented reality (AR) immersive digital device

16. The method of claim 11 wherein facilitating the online transaction takes place over a cloud-based network using a virtual reality (VR) immersive digital device.

17. The method of claim 11, wherein the online transaction is the purchase of a product or service.

18. (canceled)

19. The method of claim 11, further comprising training the subvocalization machine learning module and the gestural machine learning module using one or more of a large language model (LLM), convolutional neural network (CNN), recurrent neural network (RNN), support vector machine (SVM), random forest, hidden Markov model (HMM), autoencoder, principle component analyzer, Bayesian network, k-nearest neighbor algorithm, reinforcement learning algorithm, Gaussian mixture model, or a transfer learning model.

20. (canceled)
